(19) United States
(12) Patent Application Publication
(10) Pub. No.: US 2023/0289849 A1
(43) Pub. Date: Sep. 14, 2023

(54) METHOD AND COMPUTING SYSTEM FOR MATCHING DONORS WITH THE ESSENTIAL PRODUCT NEEDS OF CHARITY RECIPIENTS AND THE PROCESS OF DELIVERY FROM RETAILER DIRECTLY TO THE RECIPIENT

(71) Applicant: RonDerrick Johnson, Dallas, TX (US)

(72) Inventor: RonDerrick Johnson, Dallas, TX (US)

(21) Appl. No.: 18/108,645

(22) Filed: Feb. 12, 2023

Related U.S. Application Data
(60) Provisional application No. 63/318,033, filed on Mar. 9, 2022.

(51) Int. Cl. G06Q 30/0279; G06Q 50/00; G06Q 20/10; G06Q 20/32; G06Q 20/12; G06Q 20/40; G06Q 30/0207

(52) U.S. Cl. CPC G06Q 30/0279; G06Q 50/01; G06Q 20/108; G06Q 20/3267; G06Q 20/127; G06Q 20/3263; G06Q 20/4014; G06Q 30/0236

(57) ABSTRACT

A system and method for facilitating the donation and delivery of one or more essential products to Recipient and Charity Organization users are disclosed. For generating an interface that allows users to communicate within the social donating network described, but not limited to, the present mobile invention. methods, systems, devices, and the like for identifying the needs of indigent recipients such as individuals, families, and charity organizations. The system comprises an interface module for creating an interface that allows users to interact with the system; a module to create user profiles; a web profiling module that allows Recipient-User to create profiles within the system and distribute those profiles to potential Donor-Users. User, an order form is created which would then forward the essential-product request to a third-party delivery and personal shopper organization that would shop for the essential-Product-Donation request and deliver the essential products to the identified recipient(s).

### FIELD OF THE INVENTION

The present invention relates to computerized systems and methods for the matching of the essential product needs of indigent individuals, families, and charity organizations with potential Donor-Users. After the essential-product request of the Recipient-Users has been matched with a potential Donor-User identified in the mobile invention, the present invention includes systems and methods for the logistical analysis required for the delivery of the Product-Donation request from the merchant to the front door of the Recipient-User by way of a third-party delivery service.

### BACKGROUND OF THE INVENTION

The current process for donations made to individuals, families, and charities is facilitated through the contributions of monetary or used Product-Donations. These contributions of donated products are facilitated and distributed from a central hub such as Good Will or local charity organizations. The present mobile invention seeks to address the broad range of concerns associated with the present mode of giving. Particularly, there are questions regarding the misappropriation of monetary fund's given in relation to the recipient's need. How can anyone be certain that every penny that is donated is being used for the reason identified in a particular fundraiser? It is not unusual for a fundraising campaign to be falsely created in the name of a prominent entertainer, athlete, or individual in difficult circumstances. Unfortunately, some people would exploit the tragic circumstances of these heart-wrenching stories and use them to scam unsuspecting individuals out of hundreds, thousands, and even millions of dollars.

Fundraising platforms are ill-prepared to address the wide range of specific needs of those living in poverty. Many people require essential food, medical, clothing, and hygiene supplies just to name a few. Most of these needs are under-scoped and under-served due to a lack of resources. What is more, even if the resources did exist, there is no infrastructure to deliver the products to the recipients who so desperately need them. Therefore, in a feeble effort to collect the money and essential products that many require, thrift stores, donation centers, food pantries, and fundraising tools have been established throughout communities around the globe. However, a dilemma exists regarding how to eliminate the misappropriation of donated funds and the process of delivering products to recipients.

Other than the obtainment of personal receipts of purchase, it is almost impossible for a donor to know how their monetary contribution is being used. Furthermore, donation centers are poorly equipped to provide essential products and foods to people in need who lack the means to retrieve essential products. Thus, to meet the needs of the poverty community, effective logistical strategies must target the gaps that exist in the current donation systems. Such methods must address who, what, when, where, and how a Recipient-User in need will receive their donations. These are the questions that currently exist and that this mobile invention endeavors to solve to the benefit of all who are in need.

The process of managing a fundraising campaign from start to finish can be an arduous task. Ensuring that your donation contribution reaches the hands of the desired recipients can be highly complex. Multiple entities must communicate efficiently to execute successful fundraising.

For example, products often must reach the end of their product life cycle before they are considered for repurposing or redistribution. To this extent, products are then marked down in price and distributed through a secondary retailer. These include stores like the Salvation Army and the Good Will for example. Numerous contractors are in place for the receiving of both the products as well as the needs of the final recipients (e.g., those living in shelters, homeless, halfway houses, or orphanages). Many of these charity organizations lack the manpower to record the specific needs of the communities they serve. Furthermore, there is a lack of resource funding necessary to supplement what charity organizations may require hiring adequate support staff. Project budgets typically include labor, equipment such as computers, and modes of transportation for pick-up and deliveries. Also, inventory controllers, storage facilities, and customer service representatives ensure quality control as well as legal compliance.

Another barrier is the fact that many of those seeking assistance lack the means of transportation to pick up their products should they become available. If a charity has the essential products that a recipient requires, if that person is disabled or immobile, they are unable to reach the facilities to retrieve the donation. In some cases, an indigent recipient may receive financial support which would do little to assist a person if they are unable to properly spend the funds. These are just a few of the budgeting areas that impede the efficacy of meeting the needs of impoverished communities.

Whatever a charity organization receives in resources may be significantly less than what it may receive in monetary funding. Typically, the monies received have been pre-allocated for a specific subpopulation that has the most urgent needs. In this case, once the resources are depleted, many go without the products that they need. Those who seek help from charity organizations are pooled into a databank along with thousands of other recipients. Meeting the financial needs of those living in poverty is regulated to a “first come—first serve” process. While financial contributions are collected from all over the world, there are minimal safeguards in place to eliminate the misallocation and misappropriation of these funds. Misappropriation of funds means the intentional, illegal use of the funds of another person for one's own use or other unauthorized purposes. One of the primary reasons for this lack of financial accountability stems from the fact that the majority of fundraising platforms are all 501c nonprofit organizations. Therefore, they are not held to the same level of scrutiny by the IRS as their for-profit counterparts. Nonprofits are similar to corporate business entities in many aspects, although there are usually significant differences in the way operations get conducted. Nonprofit organizations have a tremendous advantage because they are not usually required to disclose their financial situation to anyone. That provision even includes members and partners of their organization. There are no disclosure requirements that can be enforced unless a violation of their 501(c) status occurs.

Because of the economic positioning of nonprofit organizations and the lack of accountability, there exists a large need to monitor more closely the contributions received by these organizations and the allocation of those funds. Most of the time, accountability measures are practiced and implemented through a board of directors and Executive Directors. Despite their best efforts, conflicts of interest and the allocation of charity organization resources may still violate government policies.

Some of the ways that funds can be misappropriated is by using restricted funds that are set aside for a particular purpose. Another way is through Solicited designations. Solicitation designation means that your organization asked for donations for a particular cause. Maybe it was by letter, email, website, or radio spot. What matters is that donations given in response to a direct solicitation are to be dedicated to that purpose. A board cannot simply redirect the use of the money from the facility's account to the food account, no matter how dire the circumstances, if those funds are the result of a solicitation.

This mobile invention will address the need to effectively get resources into the hands of individuals, families, and charity organizations in need. There are very few methods in place that can adequately identify and meet the needs of the less fortunate. Even more importantly than the need to increase donation awareness, there must be a way to systematize the appropriate allocation of financial donations. The disclosed invention seeks to provide a solution for the identification of the needs of individuals, families, and charity organizations while providing a solution to effectively deliver those resources to the home of the recipients in under an hour once a donation match has been made.

### SUMMARY OF THE INVENTION

This summary is being offered to provide a general scope of the systems and methods of the invention. These concepts will be further elaborated upon in the following detailed description. The invention stores a system of methods that are associated with existing users which are then matched with the characteristics of other existing users. Accordingly, this invention will provide the most efficient solution for delivering essential-product resources from the retailer to the front door of those in need in under an hour after a Donor-User matched has been made with the request of the Recipient User. This mobile application invention will effectively eliminate the misappropriation of funds donated to a charity organization for the acquisition of essential resources. This mobile invention discusses systems and methods which have been developed for the identification and acquisition of essential products for indigent individuals, families, and charity organizations. The mobile invention comprises four primary users which include, but are not limited to, General Recipients, Critical needs Recipients, Charity Organizations, and Donor-Users. After a user downloads the mobile application, they are taken to the onboarding process. Such users are qualified as general or critical needs recipients through the completion of the mobile invention's indigency questionnaire based on the United States poverty guidelines for the previous year. Once the users have taken the qualifying questionnaire, they are then coded as general users or critical needs users. Those identified in the system as critical needs users are those who fall below the poverty guidelines for their household. Alternatively, a general user would be those who may not meet the poverty guidelines but are unable to get the necessary products to fulfill their basic human needs.

Additionally, the mobile invention has integrated the use of multiple application programming interfaces or APIs. An API is a set of defined rules that enable different applications to communicate with each other APIs for the identification of charities, delivery of emails to users, communication with third-party delivery services, financial transactions, and in-app market stores. An API, or application programming interface, is a set of defined rules that enable different applications to communicate with each other. It acts as an intermediary layer that processes data transfers between systems, letting companies open their application data and functionality to external third-party developers, business partners, and internal departments within their companies. The disclosed mobile application invention uses APIs to verify the existence of and status of potential non-profit organizations seeking to use the mobile application.

Furthermore, the mobile application invention will schedule orders to be delivered based on a Recipient-User's address, the Recipient-User's desired store address, the information associated with one or more products, the estimated delivery time of the one or more products, and the order number. In another embodiment, a method for facilitating the delivery of one or more products is disclosed. The method includes receiving a request from a Donor-User to purchase the essential items for the Recipient-User from a desired store. The request includes types of one or more products, the cost of one or more products, the quantity of one or more products, and a purchaser address. The mode of delivery includes receiving the purchased request, shopping for the essential products through a personal shopper, and the delivery of the essential products from the retail locations to the desired location. The method further includes determining the personal shopper for delivering one or more products from the desired store to the purchaser based on the received request, received mode of delivery, and predefined information. The received request is forwarded to the third-party personal shopper. Further, the method includes obtaining approval from the personal shopper for the received request of the Donor User. The order schedule includes the purchaser's address, desired store address information associated with one or more products, and the estimated delivery time of one or more products.

Donor-Users must have a bank record or written communication from a representative from the mobile application invention for any monetary contribution before the Donor-Users can claim a charitable contribution on their federal income tax returns. Donor-Users are responsible for obtaining a written acknowledgment from a charity for any single contribution of $250 or more before the Donor-Users can claim a charitable contribution on their federal income tax returns. A Donor-User cannot claim a tax deduction for any single contribution of $250 or more unless the Donor-User obtains a contemporaneous, written acknowledgment of the contribution from the Recipient-User organization.

The mobile invention will assist a Donor-User by providing a timely, written statement of the Donor-contributions containing:
1. The name of the organization
2. The amount of donation contribution
3. A statement that no goods or services were provided by the organization in return for the contribution (see below).
4. Date of their donation

Examples of Written Acknowledgments to be provided through the mobile invention. “Thank you for your cash contribution of $300 that (eBono—name of organization) received on Dec. 12, 2024. No goods or services were provided in exchange for your contribution.”

The following is an example of a written acknowledgment when a charity accepts contributions in the name of one of its activities: “Thank you for your contribution of $450 to (eBono—organization's name) made in the name of its Special Relief Fund program. No goods or services were provided in exchange for your contribution.”

The disclosed mobile invention has integrated security to make the design of the application more complex internally, to make it more difficult for attackers to see the clear operation of the app, which may reduce the number of attack vectors. The code is formatted to increase the difficulty of examination by malicious users. Obfuscate all sensitive application code where feasible by running a code obfuscation program using either third-party commercial software or open-source solutions. By incorporating a system call, an application can instruct the operating system to not allow a debugger to attach to a process. By preventing a debugger from attaching, an attacker will not be able to interfere or analyze with the low-level runtime variables and system info. An attacker must first work around the debugging restrictions to attack an application at the base level. This adds further complexity to an attack.

The mobile invention is coded to determine whether it is being tracked by a debugger or another debugging tool. If it is being traced, the application is programmed to respond with actions for possible attack scenarios, such as notifying a server administrator, discarding or disallowing access to encryption/decryption keys, or other such response actions to defend itself. The code will allow the storage of the data locally to ensure that no sensitive data is stored on the client side. Sensitive data is minimized which is stored on the device. Any data that is stored is protected in storage by encrypting it using a strong algorithm before storage.

Communication between the application and the servers is always secure and the data transmitted cannot be intercepted or exploited by MITM attacks. The mobile invention incorporates encryption and SSL certificates (TLS 1.2) to ensure data is not intercepted during transmission. Sensitive data such as passwords and card numbers are never logged. The mobile invention is configured so that iOS and Android applications cannot cache web data, particularly secure (HTTPS) traffic which may contain sensitive or private information. The server headers are set to instruct the browser/app not to cache data while displaying only partial phone numbers on the device to protect privacy. Additionally, security is enhanced by instructing a session timeout and not keeping the user logged in. The mobile application invention will release regular patches for the mobile payment applications to ensure the app addresses all potential security loopholes which may exist or come up.

A sub-process method of the present invention enables a subject to request donations from Donor-Users. To that end, the sub-process begins with a step by prompting transmitting, using the communication device, the subject donation request to at least one Donor-User device. The subject donation request is a payment area on a webpage associated with the information from the subject's campaign. The subject user may send the subject donation request to at least one Donor-User, to potentially receive a Donor-User donation. Returning again to the example, after a subject donates $50 to their inviter's campaign, they are then able to create their own Product-Donation Campaign and send out donation requests to various people within their contact lists.

Also disclosed herein there exists a computing system that consists of a network interface, one or more processors, a non-transitory computer-readable medium (CRM), and programming instructions stored on a non-transitory computer-readable medium which is executable by at least one processor to allow the computing system to configure and carry out the functions disclosed herein. These functions include but are not restricted to the functions of the specified method. Additionally, the invention consists of a non-transitory computer-readable medium inclusive of software that is executable to initiate a computing platform to administer the functions disclosed herein.

### BRIEF DESCRIPTION OF THE DRAWINGS

The disclosure will be described and explained with additional specificity and detail with the accompanying figures in which:

FIG. 1—This is an online platform designed to enable the facilitation and management of user data and to be hosted on a centralized server such as a cloud computing service.

FIG. 2—Is an illustration of a system consistent with a method of mobile application invention which may include an electronic apparatus or cloud service. In a basic configuration, electronic apparatus may include at least one processing unit and system memory.

FIG. 3, Is an illustration of a third-party service provider computer includes one or more payment processing applications, which may be configured to process payment information received from the merchant device or from a selection at the primary user device. The payment application of the merchant device may receive payment information from users of the mobile application invention to purchase a good offered by the merchant.

FIG. 4, Is a system used for the execution of the method of the present mobile application invention which allows the present invention to function as a way for a user to leverage their network of donor users to gain exponentially more donations for their product-donation request.

FIG. 5, Is an illustration of the payment System that has been implemented within the mobile application invention to provide efficient digital payment and tracking methods for agreements established between the Donor-Users and the mobile application invention.

FIG. 6, Is an illustration of the system used to execute the method of the present invention which allows the present invention to function as a way for a Recipient-User to leverage their network of potential Donor-Users to gain exponentially more Donor-Users for their product-donation request.

FIG. 7 Is an exemplary embodiment of the disclosed system that includes a processor and a memory. The disclosed processor is any logic circuitry that responds to, and processes instructions received from the memory and including microprocessors.

FIG. 8A Is an illustration in which the Recipient-Users download the mobile application invention, go through the onboarding process, search for essential product donations, and make a request to donors and charity organizations.

FIG. 8B, is an illustration in which the user is required to enter the received OTP and tap verify button. If the user is new, they are required to set a password that can be used for logging into the mobile application.

FIG. 8C, Is the graphical user interface screen of the mobile application for depicting the product details page which displays all details of a selected product from one or more products.

FIG. 8D, Is the graphical user interface screen of the mobile application depicting the delivery methods screen. By using the delivery methods page the user may select a mode of delivery of one or more products. In the current scenario, there are two modes of delivery i.e., pick-up and personal shopper.

FIG. 8E, is the graphical user interface screen of the mobile application depicting a payment summary page. By using the payment summary page, the donor may view the total price, delivery details, and grand total, as shown in FIG. 8E.

FIG. 9, The Fintech module can provide for the linking of bank accounts for holding the funds. For example, the user can link their bank account with their profile on the system.

FIG. 10, Is an illustration of a sub-process method of the present mobile app invention which enables the Donor-User to donate to the Recipient-User's product-donation request.

FIG. 11, Is an illustration in which the user may tap on the list icon to add the product to one or more shopping lists. When the user taps on the list icon, the list icon turns into a minus icon. When the purchaser again taps on the minus icon, the product is removed from one or more shopping lists and the minus icon turns into the list-icon again.

FIG. 12, Is an illustration of the Recipient-User in which they are prompted to select the estimated cost of their product-donation request. The reason the Recipient-Users are asked to select the estimated cost of their product donation is that the system will pause their account for a predetermined amount of time according to the cost of the essential products being requested.

FIG. 13, Is an illustration of the Recipient-Users in which they are instructed to narrow their essential-product search by selecting from a list of essential-product categories. Essential items include but are not limited to Non-perishable foods, infant/childcare products, hygiene products, over-the-counter medications, essential household cleaning supplies, essential clothing, and essential pet needs.

FIG. 14A, is a module which is configured to receive charity information through its API integration, from the desired charity organization.

FIG. 14B, the charity information is made available for the purpose of verifying the non-profit status of the charity organization.

FIG. 14C, Illustration of the essential products located but not limited to retail stores, department stores, thrift stores, specialty stores, supermarkets, convenience stores, drug stores, discount stores, and E-commerce stores.

FIG. 15, a sub-process method of the present mobile invention enables Donor-User to contribute funds based on their assessment of the product-donation request and the cost of the products.

FIG. 16, Is a sub-process method of the present invention enables the Donor-User to share the Recipient-User's Product-Donation request to their social network after receiving the Recipient-user's product-donation request created by the recipient' user.

FIG. 17, Is a sub-process method of the present invention enables users of the mobile application to store their information with the present invention to be used or accessed later.

FIG. 18, Is a computing system for facilitating the delivery of one or more products comprised of one or more hardware processors; and a memory coupled to the one or more hardware processors, wherein the memory comprises a plurality of modules in the form of programmable instructions.

FIG. 19, Is an illustration of a block diagram that illustrates the systems and methods of the computing environment capable of facilitating product donation deliveries. The data receiver module is designed to receive a request from a Recipient-User to purchase one or more essential items from a desired store.

FIG. 20, Is an illustration which reflects when payment is processed, the order corresponding to the product donation request may be placed successfully.

FIG. 21, Further, the recipient user may select the “buy it” option to access a geolocation page for the graphical user interface screen of the mobile application for depicting the geolocation page.

FIG. 22 is a graphical user interface screen of a mobile application capable of facilitating delivery of the one or more products, in accordance with another embodi-ment of the present disclosure.

FIG. 23, Is a graphical user interface screen of the mobile application depicting the delivery methods screen.

FIG. 24, Is the graphical user interface screen of the mobile application showing the payment of a product donation, what products were purchased, along with its pertinent details for delivery.

FIG. 25, Is an illustration which includes details for the Donor, Recipient, and Charity organization Users regarding the history report of their product donations which include product details and delivery details shown in the mobile application.

### DETAILED SPECIFICATION/DESCRIPTION OF THE INVENTION

The following invention description reflects the various illustrative embodiments. Reference is made to the provided drawings of various embodiments which demonstrate aspects of the disclosed mobile application invention as well as its intended use. It is to be understood that additional embodiments may also be used along with structural modifications without deviating from the overarching scope of the present disclosure. The written description of the disclosed mobile application invention enables one of the ordinary skills to make and use what is considered presently to be the best mode of operations. It will nevertheless be understood that no limitation of the scope of the disclosure is thereby intended. Those of ordinary skill will understand and appreciate the existence of variations, combinations, and equivalents of the specific embodiment, method, and examples herein. The invention should therefore not be limited by the described embodiment, systems, method, and examples, but by all embodiments and methods within the scope and spirit of the invention as claimed. It will be understood by those skilled in the art that the foregoing general description and the following detailed description are exemplary and explanatory of the disclosure and are not intended to be restrictive thereof.

All technical and scientific terms used herein are intended to be used as generally understood by those skilled in the industry to which this disclosure belongs. The system, methods, and examples provided are illustrative and not intended to be limiting. The term “module” or “subsystem” should be understood to encompass a tangible entity that is physically constructed and permanently hardwired or programmed to operate in a certain manner to perform specified operations.

Many charity organizations operate in accordance with traditional building locations. However, there is an ever-increasing trend of charity organizations transitioning to an online platform to extend resources and services to their customers. The disclosed mobile application invention is intended to make use of the internet as a tool to facilitate the identification of recipients and their needs, potential donor-users, the allocation of financial donations from the donor-users, as well as the purchase and delivery of essential product-donation. The mobile application invention used the term Internet is a collection of local area networks (LANs), wide area networks (WANs), remote computers, and routers that use the Transmission Control Protocol/Internet Protocol (TCP/IP) to communicate between those networks. Also, the mobile application invention uses the term World Wide Web (WWW) to describe a collection of interconnected and electronically stored information located on servers that are connected to the internet. Users will use their digital devices to access the internet which will be the primary mode of communication between the users in accordance with the present mobile application invention.

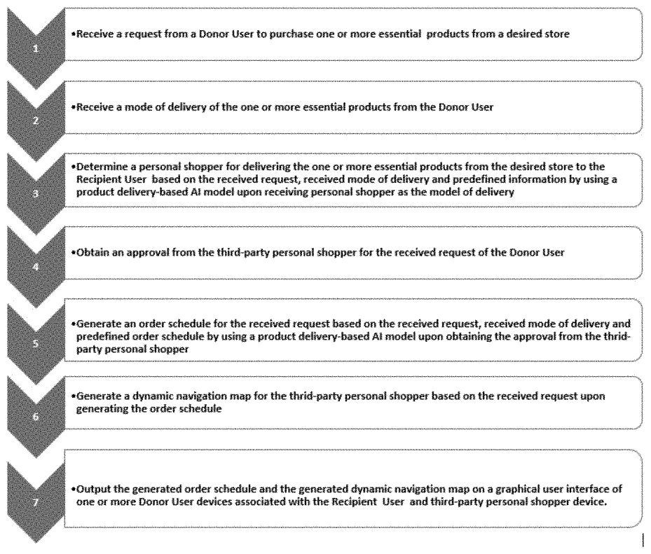

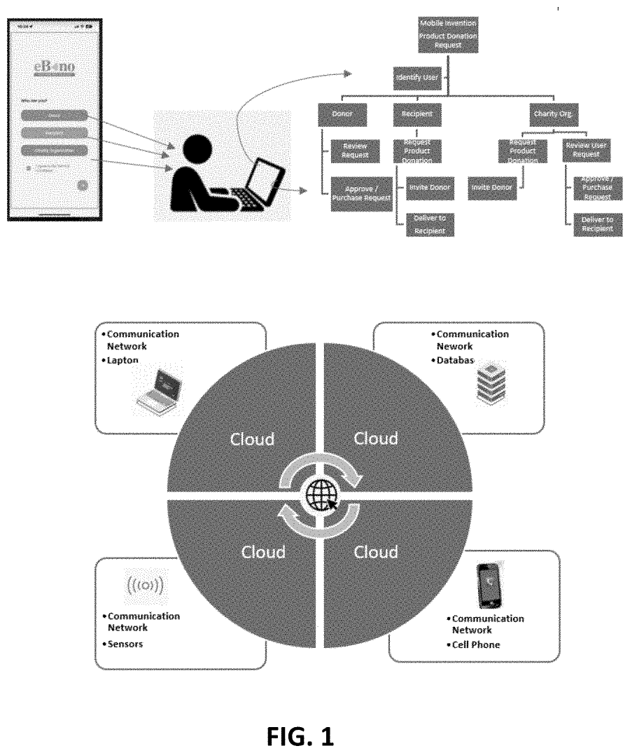

FIG. 1—This is an illustration of an online platform that incorporates various embodiments of the present mobile invention disclosure. The online platform was designed to enable the facilitation and management of user data and to be hosted on a centralized server such as a cloud computing service. The centralized server is designed to communicate with other network entities, like desktop computers, smartphones, mobile devices, tablets, laptops, tablet computers, etc. Other electronic devices and server computers include databases and sensors over a communication network such as the Internet. Various users of the online platform may include, third-party delivery services, department stores, grocery stores, medical facilities, end-users, administrators, charity organizations, service providers, service consumers, government facilities, and so on. The disclosed mobile application invention was designed to be operated by one or more relevant parties who are in communication with the disclosed mobile application invention.

A web-based software application or browser may be used to allow relevant users the ability to gain access to online platforms. The web-based software application may be externalized as a website, desktop application, web application, and/or mobile application compatible with an electronic apparatus. As can be seen in FIG. 1, the preferred embodiment of the present mobile application invention is a method for facilitating essential product-donations and the delivery of the items directly from the retailer to the recipient-user in under an hour after a donor-user has accepted the product-donation request from a recipient-user. As can be seen in FIG. 1 various users are defined as, but not limited to the following:

Product donations in the disclosed mobile application invention are defined as essential items listed in stores that are made available within the platform of the mobile application invention. Essential items include but are not limited to: Non-perishable foods, infant/childcare products, hygiene products, over-the-counter medications, essential household cleaning supplies, essential clothing, and essential pet needs. The essential item list is a non-exhaustive list that can and will be added to in accordance with the needs of the recipient-users. The provided categories will display all of the products which would be currently listed in the mobile invention database. Recipient-Users in the disclosed mobile invention is defined as an individual who would download the mobile invention for purposes of receiving product donation for essential items.

Donor-users in the disclosed mobile application invention are defined as an individual who would download the mobile invention to donate funds to be made available for the purchase of product donations. Charity-organization have a dual use in the mobile application invention. Charity-organization users in the disclosed mobile application invention are defined as individuals who would download the mobile invention to receive product donations for essential items. Additionally, charity-organization users in the disclosed mobile invention are defined as an organization that would download the mobile application invention to donate funds to be made available for the purchase of product donations.

FIG. 1, Is an illustration of the function of the mobile application invention includes: the Recipient-Users download the mobile application invention, go through the onboarding process, search for essential product donations, and make a request to donors and charity organizations. Donor-Users download the mobile application invention, go through the onboarding process, and search for recipient-users they would like to contribute financial donations to purchase their essential item request. Charity-Organization Users would download the mobile application, go through the onboarding process, search for essential product donations, and make a request to donors. Charity-Organization Users would also download the mobile application invention, go through the onboarding process, and search for recipient-users who would like to contribute financial donations to purchase their essential item request.

The method of the disclosed mobile application invention allows its users to expand their network of supporters and potential Donor-Users to fund their product-donation request. This method allows individuals to easily expand their reach using multiple social media and communication platforms through the mobile application invention. The invention increases the visibility and awareness of the user when inviting their contacts and charity organizations to donate to their product-donation request.

One example of a user expanding their reach, but not limited is: When the Recipient-User sends out a product-donation request, potential Donor-Users are required to download the mobile app invention to contribute to the product request. If the Donor-User is not able to donate to the product-donation request, they are asked to forward the request to one of the Donor-Users who they believe may be able to donate to the product request. When a potential Donor-User forwards the product-donation request, this directly increases the potential Donor-Users who may contribute to the donations that a Recipient-User may receive. In this way, the method of the present invention increases the leverage of the user when inviting their contacts to donate to their product-donation campaign.

As can be seen in FIG. 1, by way of a non-limiting example, the online platform to enable facilitating management of user data may be hosted on a centralized server, such as, for example, a cloud computing service. The centralized server may communicate with other network entities, such as, for example, a mobile device (such as a smartphone, a laptop, a tablet computer, etc.), other electronic devices (such as desktop computers, server computers, etc.), databases, and sensors over a communication network, such as, but not limited to, the Internet. Further, users of the online platform may include relevant parties such as, but not limited to Recipient-Users, Donor-Users, Charity-Organization Users, end-users, administrators, service providers, service consumers, and so on. Accordingly, in some instances, electronic devices operated by one or more relevant parties may be in communication with the disclosed mobile application invention. A user may access an online platform through a web-based software application or browser. The web-based software application may be embodied as, for example, but not limited to, a website, a web application, a desktop application, and a mobile application compatible with a computing device.

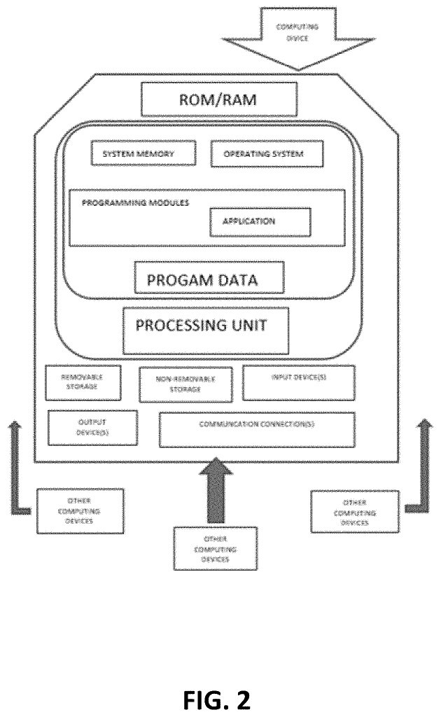

FIG. 2 is an illustration of a system consistent with a method of mobile application invention which may include an electronic apparatus or cloud service. In a basic configuration, electronic apparatus may include at least one processing unit and system memory. Depending on the framework and type of electronic apparatus, system memory may comprise, but is not restricted to, volatile (e.g., random-access memory (RAM)), non-volatile (e.g., read-only memory (ROM)), flash memory storage, or any combination. The system memory may include an operating system, one or more programming modules, and may include program data. An operating system, for example, may be suitable for controlling the computing device's operations. In one embodiment, a programming module may include an image-processing module and a machine-learning module. Furthermore, embodiments of the disclosure may be practiced in conjunction with a graphics library, other operating systems, or any other application program and are not restricted to any particular application or system. This basic framework is illustrated in FIG. 2 by those components within the outside line.

The electronic device may also include additional data storage devices (removable and/or non-removable) such as, for example, magnetic disks, optical disks, or tape. Such additional storage is illustrated in FIG. 2 by removable storage and non-removable storage. Computer storage media may include volatile and non-volatile, removable, and non-removable media implemented in any method or technology for the storage of information, such as computer-readable instructions, data structures, program modules, or other data. System memory, removable storage, and non-removable storage are all computer storage media examples (i.e., memory storage.) Computer storage media may include, but is not restricted to, RAM, ROM, electrically erasable read-only memory (EEPROM), flash memory storage or other memory technology, CD-ROM, digital versatile disks (DVD), or other optical storage, magnetic cassettes, magnetic tape, magnetic disk storage or other magnetic storage devices, or any other medium which can be used to store information, and which can be accessed by electronic apparatus. Any such computer storage media may be part of the disclosed mobile application invention.

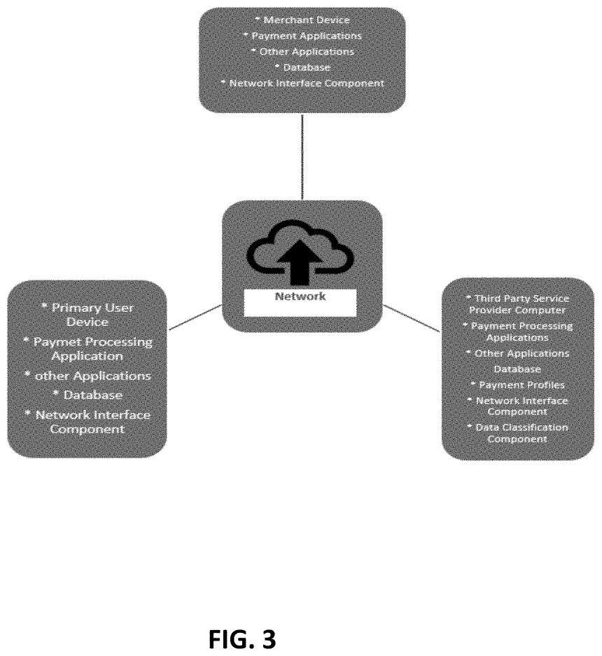

FIG. 3, Is an illustration of other applications that may include location detection applications, such as a compass, mapping, and/or GPS applications. These applications may be used to determine the location of a third-party service provider's computer or digital device. Access to a location will be needed to identify the exact location in which to deliver the Recipient-User's Product-Donation request(s). An application may also be used to request permission is each user of the mobile application user's contact list. The contact list is needed so that the user can share their profile and needs requests with potential Donor-Users and charity organizations.

Other applications may include device interfaces and other display modules that may receive input and/or output information. For example, the applications may include a GUI configured to provide an interface to one or more users. A GUI is an acronym for the graphical user interface. The GUI is used to communicate what you want to a computer application, or computer operating system, using graphical symbols rather than typing the instructions. The third-party service provider computer may further include a database, which may be stored in the memory and/or other storage devices of the third-party service provider computer. The database may include, for example, IDs such as operating system registry entries, cookies associated with the payment processing application and/or other applications, IDs associated with Components of the computer system also include a system memory component (e.g., RAM), a static storage component (e.g., ROM), and/or a disk drive. A computer system performs specific operations by a processor and other components by executing one or more sequences of instructions contained in the system memory component. Logic may be encoded in a computer-readable medium, which may refer to any medium that participates in providing instructions to a processor for execution.

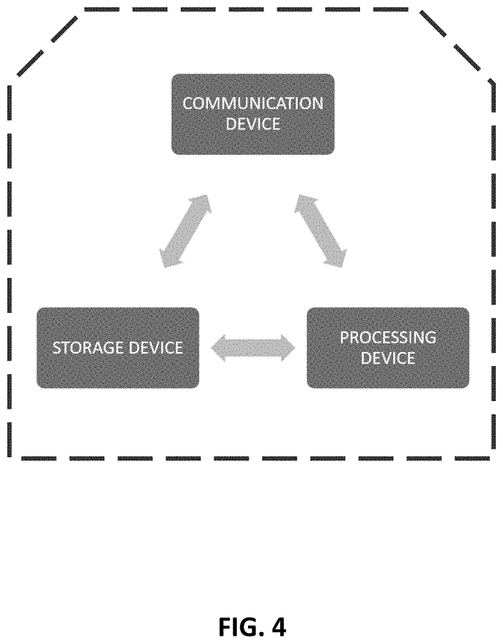

FIG. 4, Is a system used for the execution of the method of the present mobile application invention which allows the present invention to function as a way for a user to leverage their network of subject users to gain exponentially more Donor-Users for their product-donation campaign. The method of the present invention may include but is not limited to, the processes of Acquiring—Using the communicating device, a Recipient User may request a product-donation from at least one Donor User who is associated with at least one Recipient User. Using the communicating device, the Recipient User makes a product-donation request to at least one Donor User device associated with a Recipient User. Through the use of the communicating device, a Product-Donation request from at least one Recipient User device is associated with a Donor User. Through the use of the communication device a processing device, a Product-Donation request is generated for a Product-Donation. Through the use of the communicating device, a Product-Donation request is made to at least one Donor User's device associated with a multitude of Donors Users. Throughout the use of the communicating device, a Donor Product-Donation request corresponds to at least one Donor User's device.

Using a communication device, a product-donation campaign request from at least one device associated with another user such as a Donor-User. A product-donation request is a web-page-based form that included information related to the product-donation request of a Recipient or Charity Organization User as but not limited to: The title of the product-donation request, name of the Recipient-User user, contact information for the subject user such as their city, state, email, etc. The system used to execute the method of the mobile invention may include a process of using a processing device to analyze a product-donation request to be generated. The processing device executes computer commands such as turning provided information into graphical user interfaces. The product-donation request is a web-page graphical user interface that is generated by the information provided from the product-donation request. Information, in this case, would be for essential products located but not limited to retail stores, department stores, thrift stores, specialty stores, supermarkets, convenience stores, drug stores, discount stores, and E-commerce stores. For example, if the Recipient-User provides information into the product-donation request, a webpage is automatically generated for the user to display their product-donation request and its relevant information.

The system and method of the present mobile application invention may include a process of transmitting, using the communication device, the product-donation request to at least one Donor-User device associated with the mobile invention. The Donor-User device is an electronic device that is utilized by a Donor-User to receive a Product-Donation Campaign request. The system used to execute the method of the present invention may include a process of receiving, using the communication device, a Donor-User donation, corresponding to at least one Donor-User device. A Donor-User donation is a monetary amount contributed by a Donor-User from their associated Donor-User device. For example, if a Recipient-User sends out their Product-Donation request to various Donor-Users and at least one Donor-User wants to contribute to the product-donation request, the Donor-User can purchase the product-donation request on behalf of the Recipient-User through the mobile invention.

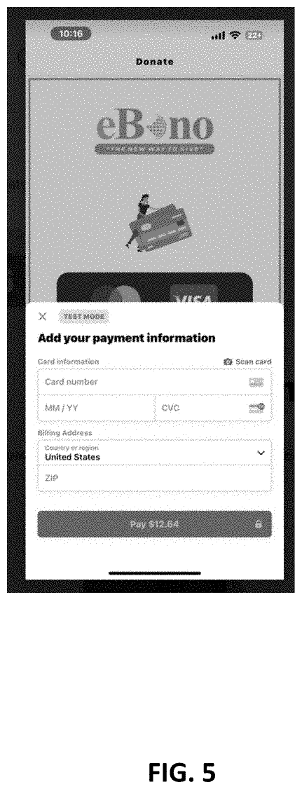

FIG. 5, Is an illustration of the payment System that has been implemented within the mobile application invention to provide efficient digital payment and tracking methods for agreements established between the Donor-Users and the mobile application invention. As used herein, the term “financial transactions” refers to all debit and credit transactions such as those purchased on near-field communication devices, cellular phones, tablets, and web-enabled systems. Payment systems and methods have been integrated into the programming of the mobile application system that includes by not limited to the following:

Stripe brings together everything that's required to build websites and apps that accept payments and send payouts globally. Stripe's products power payments for online and in-person retailers, subscription businesses, software platforms, marketplaces, and everything in between. Stripe also helps companies beat fraud, send invoices, issue virtual and physical cards, reduce friction at checkout, get financing, manage business spending, and much more. The mobile application uses Stripe to accept payments and move money globally with Stripe's powerful APIs and software solution. Stripe's server-side helper libraries (also known as server-side SDKs) and Command Line Interface (CLI) allow the mobile application invention to interact with Stripe's REST APIs.

The disclosed mobile application invention uses PayPal as part of its payment methods available today with over 254 million users worldwide. Owned by eBay, PayPal is an eCommerce payment processing company that allows users to set up a PayPal account and pay a fee for each cash transaction. Many customers prefer to checkout with PayPal because it's so simple and quick to use, not to mention its perceived level of security by online shoppers. Fees will vary depending on the currency being used and the amount transacted.

The disclosed mobile application system uses Amazon Pay as another digital payment processing service that allows customers to pay online using their Amazon payment methods on third-party websites. Amazon Pay uses the details already stored on the shopper's Amazon account to complete the transaction and provide a speedy checkout experience. Online retailers can certainly benefit from Amazon's undisputed popularity across the whole web, as the majority of the users of the mobile application users will already hold an account with Amazon.

The disclosed mobile application uses eBay Managed Payments. eBay's own payments system enables users to enter payment information and process it without having to digitally travel to a third-party site and therefore leave the marketplace. Users of the mobile application can benefit from a payment experience all through a single site, which includes multiple payment options including credit and debit cards, Google Pay, Apple Pay, and even PayPal if they choose.

The disclosed mobile application allows users to use their Google account, and Google Pay offers an extra layer of convenience for a significant number of our users. Users can also store-branded gift cards, loyalty cards, and offers with Google Pay, helping them to build brand affinity and provide a seamless shopping experience that is entirely online.

The disclosed mobile application invention uses Apple pay for our users to easily secure a faster alternative to traditional credit and debit card payments, as it skips the need to enter long card details and operates with a one-click payment process. Apple services also allow our users to authenticate their purchases using the Touch ID fingerprint sensor on Apple devices, and like Google Pay, it's completely free for both merchants and customers to use.

The disclosed mobile application invention uses Direct debit payments for automated payments to be made. The biggest plus of direct debits is the fact that payment is almost instant, so no need to wait for users to pay an outstanding invoice. This online payment method works best for regular invoices such as monthly retainers or subscription-based business models.

The disclosed mobile application invention uses bank transfers. The main benefit of bank transfers is that Donor Users don't have to disclose any financial details through the mobile application invention to donate to a recipient. What's more, bank transfers used for eCommerce payments are only set to grow due to open banking initiatives like PSD2 (Payment Services Directive 2); legislation to allow non-banks, i.e. retail merchants, to initiate payments without the intervention of traditional card brand networks.

The disclosed mobile application invention uses Prepaid cards for Donor Users. Different from gift cards, prepaid cards are a type of debit card issued by a bank or credit card company and ‘loaded’ with a certain amount of money. The card's limit is determined by the amount deposited onto the card, and once the balance has been exhausted, the card is worthless until more funds are added.

The disclosed mobile application offers the use of gift cards for Donor Users and Charity Organization Users. Gift cards contain a certain amount of money, however, they are mainly offered by retailers and, more recently, by major credit cards providers such as Visa, Mastercard, and American Express. The most common type of gift card is technically known as a closed-loop card, meaning it can only be used with a particular retailer, although some retail groups will allow the same gift card to be used at other affiliated stores.

The disclosed mobile application invention offers the use of Digital currencies. These forms of alternative online payment are based solely on the demands of our users. For example, if you are targeting millennials who are most likely to invest in crypto.

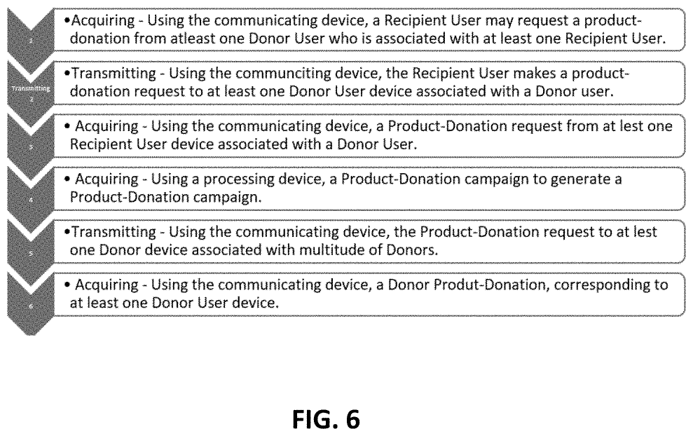

FIG. 6, Is an illustration of the system used to execute the method of the present invention which allows the present invention to function as a way for a Recipient-User to leverage their network of potential Donor-Users to gain exponentially more Donor-Users for their product-donation request. The method of the present invention may include process of receiving, using a communication mechanism, a Recipient-User product-donation request from at least one Recipient-User mechanism associated with at least one Donor-User. The Recipient-User product-donation request is a payment area linked to a webpage with information associated with the product-donation of the Recipient-User. The Recipient user's mechanism is an electronic device that allows the Recipient-User to create their product-donation request. The system used to execute the method of the present invention may include a step of transmitting, using the communication mechanism, the Recipient-User product-donation request to at least one Donor-User mechanism associated with a Recipient-User. The Donor-User mechanism is an electronic device that is utilized by a Donor-User. Each Donor-User is an individual user who receives a product-donation request from the Recipient-User user. For example, a Recipient-User may send out multiple product-donation requests and the Donor-Users are the ones who will receive the product-donation request.

The networking module can provide a social networking platform for the users to interact with others in groups. The platform can allow users to create a message, news, videos, photos, testimonials, articles, campaigns, and the like and post them in groups. The users on the platform can view and react to each other posts. The users can create their public pages that can be accessed outside the platform, wherein the users can provide information about themselves, the cause for the product-donation request created by the users, the types of donations accepted, and the like. Activities of the users can be tracked and presented on the page, such as the number of product-donations they have received, the amount of time the user has been active on the platform, the date the user joined, the city and state of the user, reason for the product-donation request, and the like. The networking module can be used to enable the user to generate product-donation requests and send those requests to directories, email lists, other social media platforms, and cellular contacts.

In an embodiment of the present mobile invention, the News Feed shows notifications from the Donor-Users and charity organizations that may track all financial contributions in real-time. The charity may go back to the home screen and select the “share” Button to access the contact list, email list, marketing, and social media, as well as WhatsApp. The share link allows users to edit and create content for their leader boards and other medial sites to thank contributors and push more donor and charity organization users to donate. Furthermore, the charity organization users may go back to their homepage and invite potential Donor-Users to download and login into the mobile application. The charity may invite potential Donor-Users through their personal email address or SMS messaging to set up an account that is linked to their charity profile. On the home page, the charity may select an option to view and edit my profile content to update the charity's information. The charity will also receive an email to notify the contact person that their charity has been verified. The charity will receive notifications when any Donor-User has accepted their product-donation request and contributed the money for the purchase of the charity organization's product request. The charity will receive notifications corresponding to the name of the Donor-User and the amount they donated for the product request.

When a Donor-User decides to accept and purchase the product-donation requested by the Recipient-User user, both the Recipient-User and Donor-User will access the mobile application using the mobile invention device. From the mobile invention, Donor-Users and charity organizations will have access to every Recipient-User donation request. The Donor-User may go to the profile/home page to select the charity to donate to. When the Donor-User selects a charity, they will have access to details such as the name of the charity i.e., we care, the title of the product-donation request, general contact information like an email address, and a brief description of the mission/vision statement of the charity and the reason for the product-donation request. Once on the charity organization's profile page, the Donor-User also has access to the product items that the charity organization is requesting for their review and verification. Further, when the Donor-User agrees to purchase the essential products, they are required to click the confirm button to provide payment details. When the confirmation is received from the charity, the donations are made as per the contact details.

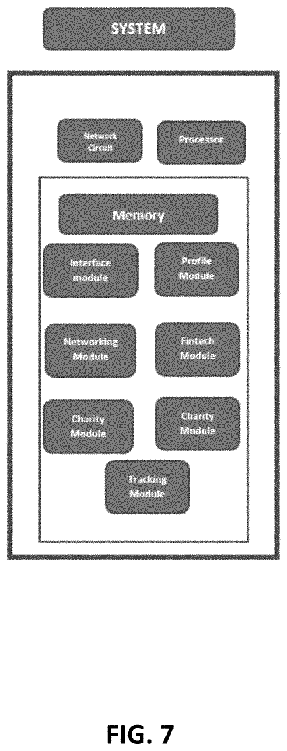

FIG. 7 Is an exemplary embodiment of the disclosed system that can include a processor and a memory. The disclosed processor is any logic circuitry that responds to, and processes instructions received from the memory and including microprocessors. The memory may include one or more memory chips used for storing data and allowing any storage location to be directly accessed by the processor. The system may also include a network circuitry that enables the disclosed system to connect external devices through a wired or wireless network which can be secured or unsecured. The wired network may include Digital Subscriber Lines (DSL), coaxial cable lines, or optical fiber lines. The wireless network may include BLUETOOTH, Wi-Fi, Worldwide Interoperability for Microwave Access (WiMAX), an infrared channel, or a satellite band. The wireless network may also include any cellular network standards used to communicate among mobile devices, including but not limited to standards that qualify as 3G, 4G, or 5G.

The disclosed mobile application system can connect recipient users and potential donor users. The disclosed system can be implemented in an environment of a single or multiple, logically grouped servers that include cloud servers which may be geographically dispersed. One or more of the servers can include an operating system platform like Windows, Unix, Linux, or Mac.

The disclosed mobile application system can include an interface module, a profile module, a networking module, a Fintech module, an investment module, a charity module, and a tracking module. The modules can be software, a functional piece of code in one or more computer-readable languages, a set of instructions, and the like which upon execution by the processor can perform one or more steps of the disclosed method.

Upon execution, by the processor, the interface module can provide an interface on an external device for interacting with the disclosed system. Upon execution by the processor, profile module that can create a profile of a user on the disclosed system. Upon execution by the processor, the networking module can provide for creating social networks and groups. Upon execution by the processor, the Fintech module can create accounts for handling transactions and depositing money. Upon execution by the processor, the charity module can provide donations and charity. Upon execution by the processor, the tracking module can track the transaction of a user on the disclosed system and determine any benefits available through donation transactions.

The disclosed mobile invention uses an interface module that can provide interfaces for interacting with the disclosed system. The users can download and upload information through the interface and provide application software that can be installed on a user's device. The application software may be created for Android, iOS, and any other known operating platform for mobile devices and computing systems. Application software is made available through a distribution service provider, for example, the app store by Apple and Google Play operated and developed by Google. A website-based interface is provided through the world-wide-web.

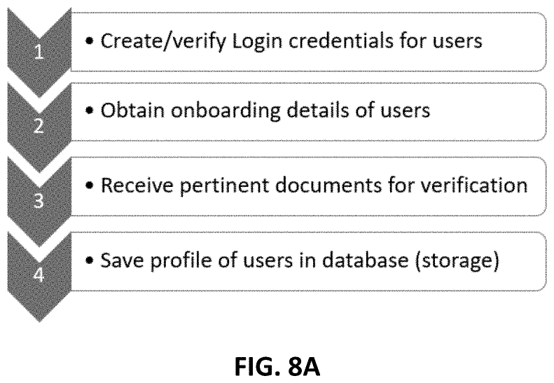

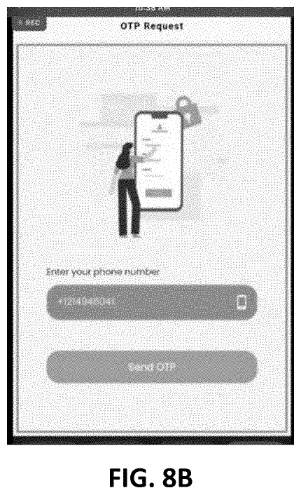

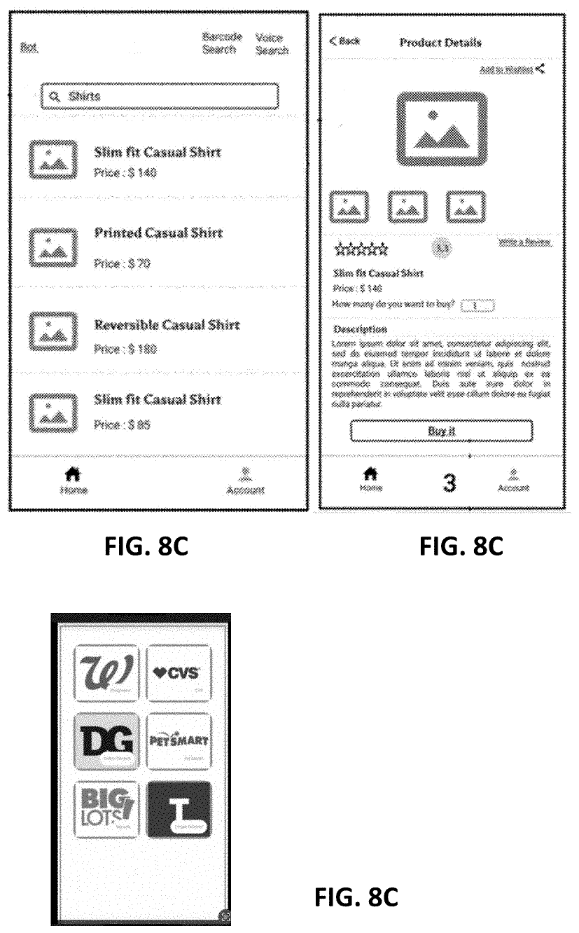

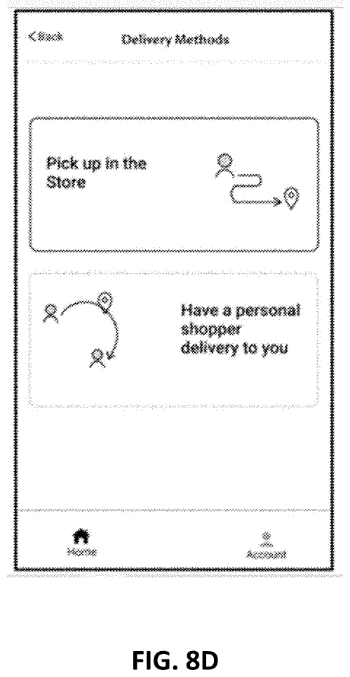

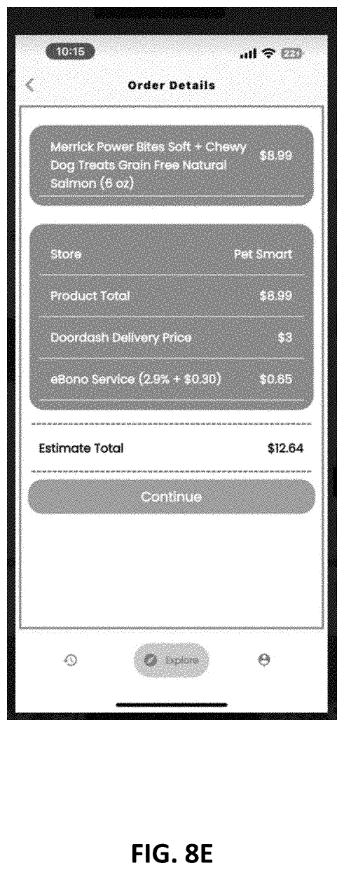

FIG. 8A Is an illustration of the profile module which allows users to register on the disclosed system. The image shows a representative embodiment of the disclosed profile module for the disclosed mobile application invention. The profile module can be used to create login credentials for a user to securely access the disclosed system through their devices, at step. User devices for the mobile application can be a laptop workstation, desktop, smartphone, tablet computer, thin client, and the like. The profile module can be used for purposes such as creating registration forms through a user interface implemented on the user device. The user interface can also receive login credentials and provide a login screen for authorized users to access the disclosed mobile application. Login credentials include a username and a password. Any alphanumeric code can be used for the password and include symbols and the like. Biometric-based logins and authentication are also within the scope of the present mobile application invention. The registration form can be used to obtain information about the user, such as name, contact details, addresses, affiliations, and like, at step. The profile module can also be used to enable the device to receive pertinent documents to verify the details of the user, such as government-issued identification documents. Third-party verification is also within the systems and methods used withing the scope of the present mobile application invention. The profile module can be used to save the profile in a quarriable database to search the profiles based on keywords. The profiles can be edited and obtained from the user after registration.

Users are first instructed to enter their telephone number to be associated with their mobile account. Next, a One Time Pin (OTP) will be generated which the user will receive through a push notification. Push notifications look like SMS text messages and mobile alerts, but they only reach users who have installed the disclosed mobile application. All the mobile platforms—iOS, Android, Fire OS, Windows, and BlackBerry, have their own services for supporting push. The user of the mobile application invention will then be asked for their email address to be associated with their account. The user will then receive a welcome email after their mobile device has been verified. After the telephone and email address has been verified the Recipient-User will be directed to enter enrollment information such as their name and address. The users are asked to provide their addresses so that the third-party delivery partner will know exactly where to deliver the Product-Donation.

Recipients will then be directed to take an indigency assessment to establish their level of need and determine if they will be coded as General or Critical Needs Recipients. The indigency assessment is based on the United States poverty guidelines for the previous year. The primary distinction of a General Recipient-User is that these users would only be able to make requests from individuals who are identified in their contact list. However, Critical Needs Recipients will gain access to additional features and services provided through the mobile application invention. Critical needs users will have priority in the pool of Recipient-Users as they will be accessible to every potential Donor-User.

(General Users)—After a user downloads the app, their first assignment will be to identify the type of user they will be such as General, Critical needs, Donor-User, or Charity Organization User. If the user selects General Recipients, they will download the mobile application and be directed to sign up by creating an account. As used herein, the term General users refer to those who are temporarily indigent and cannot afford the essential products they need to sustain basic human functions such as eating, cleaning, hygiene, and childcare. General Recipients are asked to provide access to their location.

The disclosed mobile application features a networking module that is used to provide a social networking platform for the users to interact with others in groups. This platform allows users to create news, articles, message, campaigns, and product donation requests while posting them on social and group platforms. Users of the mobile application can view and react to each other posts and create public pages that can be viewed outside the platform. Users can provide information about themselves, the reason for the product donation request, types of donations accepted just to name a few. User activities of the users can be tracked and presented on the page, such as the number of requests made by a recipient user, how much a Donor User has contributed to recipient users and charity organizations, the time a user has joined the mobile application community, and the like. The activities of the user on the platform can be tracked which can affect the rank and reputation of the user on the platform. The user of the mobile application can share links to their post on social media platforms by clicking on the like and posting them on the platform. The networking module can also allow the user to generate product donation campaigns and send campaigns to their contact list, directories, email lists, and other social media platforms. Networking modules of the mobile application invention can track the response to such campaigns and allow them to be posted on the public profile or page of the user.

FIG. 8B, is an embodiment of the present disclosure, the user is required to perform authentication before using the mobile application. The Authentication may be done via one or more user devices. Further, the user may select his country code and then enter his ten digits mobile number with no spaces or special characters. In an embodiment of the present disclosure, the mobile phone is required to have access to a cellular phone network to receive an OTP through SMS. Furthermore, the user is required to enter the received OTP and tap verify button. If the user is new, they are required to set a password that can be used for logging into the mobile application. When the registration is successful, the user may be taken to a homepage where they may search the one or more products via the manual search, the voice search, and the barcode search to buy one or more products. In manual search, the user may search for one or more products by using a search string, such that all the relevant products matching the string may be displayed. Further, in barcode search, the purchaser may search for one or more products by scanning the barcode. The products whose barcodes are stored in the storage unit may appear in the search results. In voice search, the purchaser may input his/her voice for searching for one or more products.

FIG. 8C, Is the graphical user interface screen of the mobile application for displaying the search results. The graphical user interface screen of the mobile application for depicting the product details page which displays all details of a selected product from one or more products. The user may select the quantity of the selected product from the product details page. Further, the user may select the buy it option to access a geolocation page. FIG. 4C is the graphical user interface screen of the mobile application for depicting the geolocation page. The user may select the store by clicking on the store icon in map view or the purchaser may view all the stores carrying one or more products by selecting the list of stores option.

FIG. 8C is the graphical user interface screen of the mobile application for displaying all the stores carrying one or more products and sorting of the stores is defaulted by price, distance, and stock. The graphical user interface screen of the mobile application for depicting the product details page which displays all details of a selected product from one or more products.

FIG. 8C Is an illustration in which the Recipient-Users are prompted to select from a list of stores that are made available within the disclosed mobile invention. Stores included within the disclosed mobile invention include by not limited to retail stores, department stores, thrift stores, specialty stores, supermarkets, convenience stores, drug stores, discount stores, and E-commerce stores. In the illustration, the graphical user interface screen of the mobile application for displaying all the stores carrying one or more products and sorting of the stores is defaulted by price, distance, and stock. The user may always have the option to sort the stores by price or distance or stock. The graphical user interface screen of the mobile application for displaying the search results. The purchaser may select the quantity of the selected product from the product details page. Further, the purchaser may select the buy it option to access a geolocation page. The graphical user interface screen of the mobile application for depicting the geolocation page. The purchaser may select the store by clicking on the store icon in map view or the purchaser may view all the stores carrying one or more products by selecting the list of stores option.

FIG. 8D, Is the graphical user interface screen of the mobile application depicting the delivery methods screen. By using the delivery methods page the user may select a mode of delivery of one or more products. In the current scenario, there are two modes of delivery i.e., pick-up and personal shopper.

FIG. 8E, Is the graphical user interface screen of the mobile application depicting a payment summary page. By using the payment summary page, the donor may view the total price, delivery details, and grand total, as shown in FIG. 8E. In an embodiment of the present disclosure, the donor may select the continue option to access the payment page. The graphical user interface screen of the mobile application depicting the payment page. By using the payment page, the donor may select any payment method pay as debit/credit, proprietary Pay Balance, Apple Pay, or ACH, and can proceed with payment. Once payment is processed order corresponding to the request may be placed successfully.

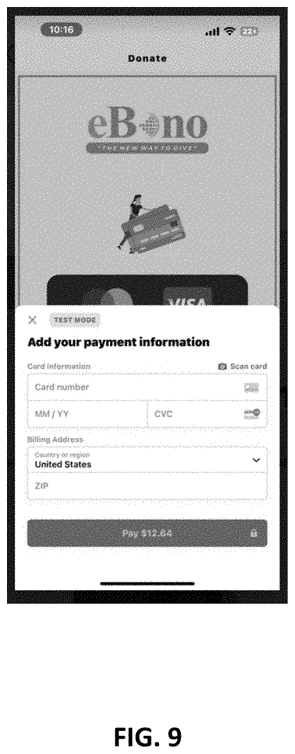

FIG. 9 is the graphical user interface screen of the mobile application showing saved payment cards. The graphical user interface screen of the mobile application for accessing open orders, closed orders, canceled orders, profiles, wallets, and the like. Furthermore, the donor and the recipient are notified that the order has been successfully delivered. The Fintech module can provide for the creation/linking of bank accounts for holding the funds. For example, the user can link their bank account with their profile on the system. The Fintech module provides a payment interface through which money can be received and deposited in the linked account. Users of the mobile application invention can send links, account details, QR codes, and the like to people for product donations. Links can be used to make a direct donation by transferring money into the account. The Fintech module may also provide a donor-advised fund account linked to their profile for any funds directed to 501(c)(3) charities. The disclosed Fintech module can be used to create similar accounts according to local tax rules for charities. The Fintech module helps to ensure compliance with local charity laws and tax-saving donations. The Fintech module can assign each transaction with details such as the source, purpose, date, and time, of the funds. The Fintech module can be used to present records of each transaction through an interface for both debit and credit accounts.

The Fintech module can link the donor, for example, Mr. X donates USD by transferring the amount to the account of the user. The donor X can transfer an amount to recipient Y for the purpose to which X donated the amount. The Fintech module can present the interface showing both credit and debit entries, with the source and destination of funds, the purpose for which the donations were made, and the like. While there could be multiple donors from which funds are received into an account, the Fintech module can provide an option to choose a donor from which funds can be transferred to the recipient of the donation based on the purpose of the donation. The transaction can be grouped by the cause for which the donations are received and transferred to the recipient. Each cause promoted by the user can be given a unique id and that unique id can be embedded in the transactions related to the cause. Thus, money collected for a particular cause and distribution of the money in charities can be tracked using the unique id for that cause. Moreover, the Fintech module may automatically regulate the legal compliance for charities and donations, such as 501(c)(3) charities and people/organizations eligible to receive the 501(c)(3) charity. The automation of legal compliance allows the user to focus more on promoting the cause by collecting money for charities. Also, the Fintech module can allow receiving payments through different sources, such as local and international direct bank transfers, credit cards, debit cards, and online payment systems such as PayPal™. The Fintech module can also provide for receiving digital currency, such as Bitcoins, and conversion of the digital currency into local currency. The Fintech module can also generate suitable receipts for payments to avail of any tax benefits. The fintech module can provide for receiving and making payments and transfers of and from assets on the investment module to 501(c)(3) charities, individuals, and indi-viduals as recipients of distribution from a 501(c)(3) charity.” And its ability to track the value of those investments.

The charity module can allow persons and organizations, referred to herein as recipients, willing to receive charities to register themselves on the disclosed system. The charity module will assign a unique ID to each charity organization user. Bank account details of recipients can also be taken to which the money can be transferred. The tracking module can track the activities of the user, such as the creation and promotion of causes, and based on the activities, suitable rewards can be provided to the users.

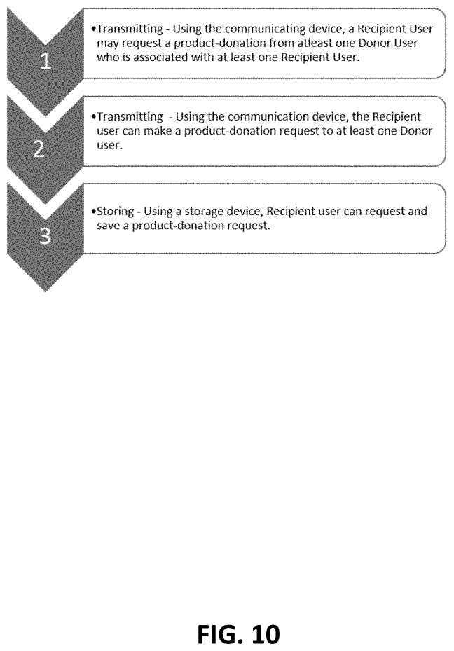

FIG. 10, a sub-process method of the present mobile app invention enables the Donor-User to donate to the Recipient-User's product-donation request. The sub-process starts by transmitting, using the communication device, the recipient user product-donation request to at least one Donor-User. The Recipient-User's product-donation request is sent to multiple potential Donor-Users allowing each the opportunity to contribute. The sub-process continues by transmitting, using the communication device, the product donation to the Donor-User. The product donation is a monetary amount associated with the Recipient-User that is sent to the Donor-User to support the Recipient-User's product-donation request. The subprocess continues by storing, using a storage device, the product-donation request. The storage device is an electronic device designed for performing data storage or data retrieval operations. The product donation is recorded and stored within a storage device for later access and use. For example, as a product donation is received by the present invention, the monetary amount is stored within the storage device until the amount is transferred for use within the mobile invention.

FIG. 10 is the graphical user interface screen of the mobile application for providing desired personal choice price, recipient address, estimated delivery time, and the like. Further, order details including product details and delivery details are shown to the purchaser. The graphical user interface screen of the mobile application depicting the order placed page including order ID, delivery method, store address, and the like. A graphical user interface screen of a mobile application capable of managing one or more shopping lists, in accordance with an embodiment of the present disclosure.

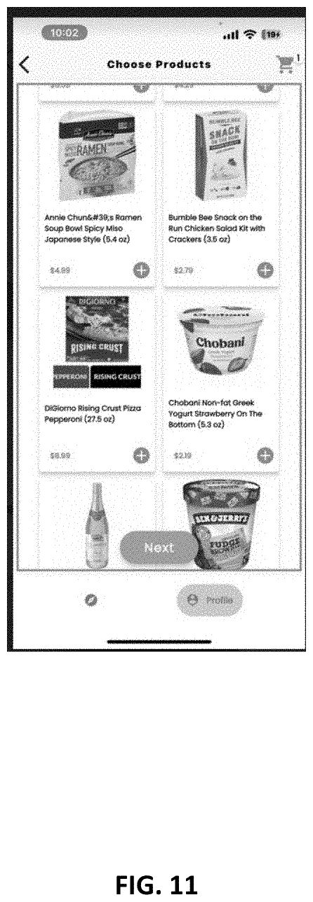

FIG. 11 is the graphical user interface screen of the mobile application for adding and removing products from one or more shopping lists. The purchaser search for a product in the search window. The search result may include an exact product or similar products. The user may tap on the list icon to add the product to one or more shopping lists. When the user taps on the list icon, the list icon turns into a minus icon. When the purchaser again taps on the minus icon, the product is removed from one or more shopping lists and the minus icon turns into the list-icon again. In the current scenario, the country delight vitamin D milk is added to the shopping list by tapping the plus icon. When the user long press on the product, the purchaser is directed to the next page where the purchaser may add product specifications and add the product to a wish list. In an embodiment of the present disclosure, one or more shopping lists are stored in the storage unit. The user may add products to already created one or more shopping lists or the user may also create a new shopping list. While creating the new shopping list, the user is required to name it.

As disclosed in FIG. 11 is a graphical user interface screen of a mobile application capable of managing one or more shopping lists, in accordance with an embodiment of the present disclosure. Essential products that are included in the shopping list are gathered from retail stores, department stores, thrift stores, specialty stores, supermarkets, convenience stores, drug stores, discount stores, and E-commerce stores. In an embodiment of the present disclosure, the mobile application is used by the Recipient-User. The graphical user interface screen of the mobile application for adding and removing products from one or more shopping lists. The Recipient-User searches for a product in the search window. The search result may include the exact product or similar products. The user may tap on the plus icon to add the product to one or more shopping lists. When the purchaser taps on the (minus) icon, the product is removed from one or more shopping lists. In the current scenario, the country peaches are added to the shopping list by tapping on the (plus) icon. In an embodiment of the present disclosure, one or more shopping lists are stored in a storage unit. The Recipient User may add products to a preexisting shopping list, or the Recipient User may create a new shopping list. The shopping list is a culmination of what the Recipient-User is requesting to be donated by the Donor-User through the present mobile application invention. The illustration reflects a list of all of the products requested by the Recipient User is created for the purposes to be reviewed by potential Donor Users. The list reflects all of the categories comprising all products searched and added to the product donation request. A search tool is used by the Recipient Users to locate essential items from the stores listed in the mobile application invention. The query is submitted by the query server via the search tool to a separate database associated with each category. Each product database is indexed by keyword to facilitate searching by the search tool.

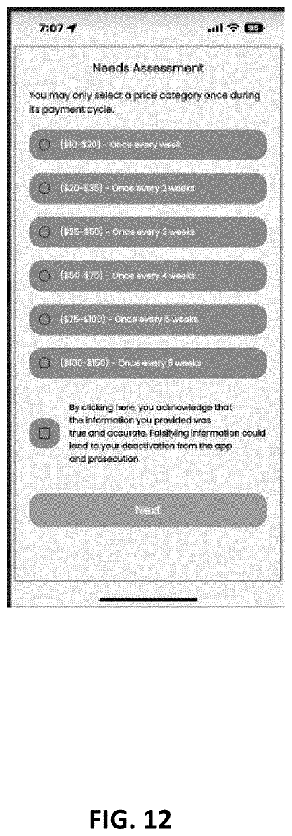

FIG. 12, Is an illustration of the Recipient-User who is prompted to select the estimated cost of their product-donation request. The reason the Recipient-Users are asked to select the estimated cost of their product donation is that the system will pause their account for a predetermined amount of time according to the cost of the essential products being requested. The reason the user's system is paused is to prevent abuse of the disclosed mobile application so that no user will be able to continuously make product donation requests. The categories of the price estimates are subject to price adjustments and changes including but are limited to nor intended to be restrictive: Price categories for the Recipient-Users are: $10-20 dollars (once every week), $20-35 dollars (once every two weeks), $35-$50 (once every three weeks), $50-$75 (once every four weeks), $75-$100 (Once every five weeks) and $100-$150 (Once every six weeks). After the Recipient-User selects a price category, the Recipient-User accounts will be paused for the specified time in which they will no longer be able to select that price category for a predetermined time. The mobile invention will notify each user of the amount of time and date they have remaining until they can make another product-donation request. This feature acts as a security system and method to prevent abuse of the mobile application invention.

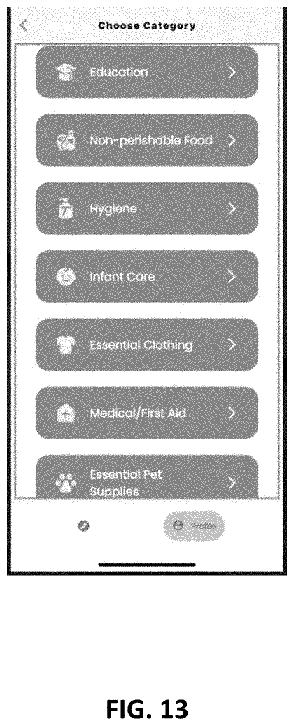

FIG. 13, Is an illustration where the Recipient-Users are instructed to narrow their essential-product search by selecting from a list of essential-product categories. Essential items include but are not limited to Non-perishable foods, infant/childcare products, hygiene products, over-the-counter medications, essential household cleaning supplies, essential clothing, and essential pet needs. The essential item list is a non-exhaustive list that can and will be added to in accordance with the needs of the recipient users. The provided categories will display all of the products which would be currently listed in the mobile invention database. The mobile application can store in memory the essential products listed in the retail stores listed that are made available in the mobile invention.

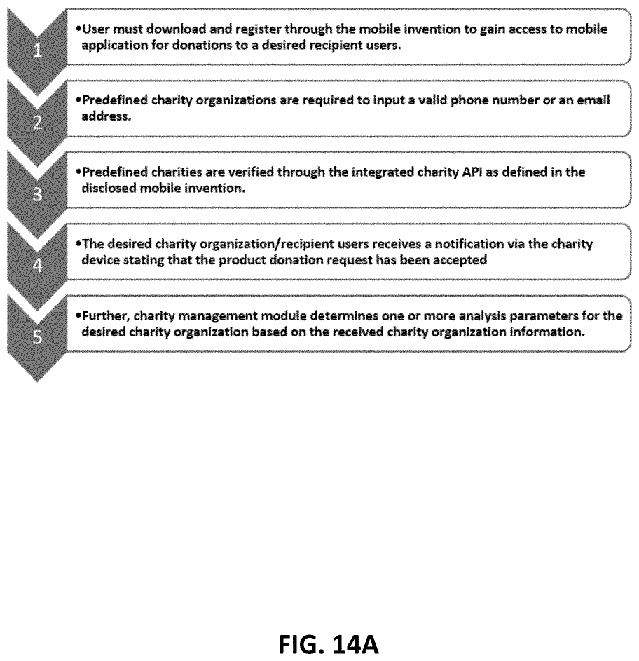

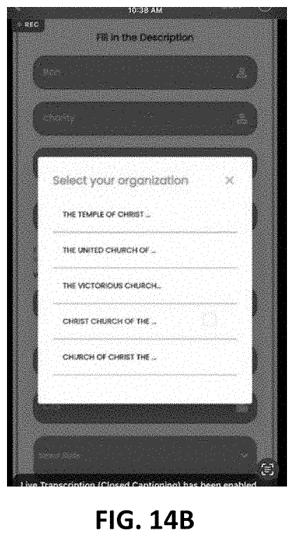

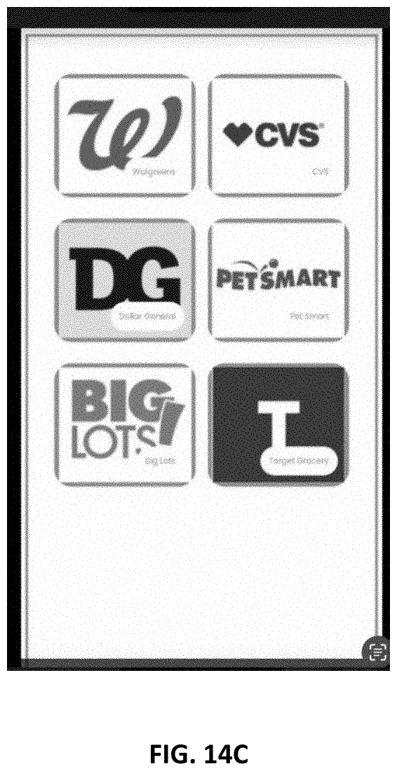

FIG. 14 is an illustration of a module which is configured to receive charity information from the desired charity organization. The charity information is made available for the purpose of verifying the non-profit status of the charity organization. The charity organization must be verified as a security measure of the disclosed mobile invention before a Donor-User can contribute donations to the organization. The disclosed mobile invention has integrated the use of APIs within its constructs to help facilitate the systems and methods described in the mobile invention. The mobile invention has integrated the use of APIs for the identification of charities, delivery of emails to users, communication with third-party delivery services, financial transactions, and in-app market stores. An API, or application programming interface, is a set of defined rules that enable different applications to communicate with each other. It acts as an intermediary layer that processes data transfers between systems, letting companies open their application data and functionality to external third-party developers, business partners, and internal departments within their companies. The mobile invention uses APIs to verify the existence of and status of potential non-profit organizations seeking to use the mobile application to obtain product donation contributions.

FIG. 14B is an illustration of A Donor-User or Donating Charity organization-user a combination thereof must download and register through the mobile invention to gain access for making donations to a desired charity identified in the mobile invention or to a Recipient-user. In an embodiment of the present disclosure, one or more predefined charities are required to sign-up using their charity device, such that the desired store and the purchaser may provide charity information corresponding to one or more predefined charities. In an embodiment of the present disclosure, while signing up, one or more predefined charities are required to input a valid phone number or an email address. Further, one or more predefined charities are required to provide the email address and create a password. One or more predefined charities are also required to enter their charity name and a description of why are raising money. Furthermore, all the details provided by one or more predefined charities are verified through the integrated charity API as defined in the disclosed mobile invention. One or more predefined charities may provide a valid document and/or identifying government-issued Electronic Identification Number (EIN), tax identification number, or a combination of these identifying numbers. These numbers and any other provided documentation may be reviewed and verified. The charity information may include one or more purchaser parameters received from the purchaser and one or more store parameters received from the desired store.

FIG. 14C In an exemplary embodiment of the present disclosure, one or more purchaser parameters include the name of the charity, the amount to be donated to charity, the essential product items they are requesting, and the like. Select the desired store. In an exemplary embodiment of the present disclosure, one or more store parameters include the name of the desired store, the custom amount of revenue to be donated, the time frame for donation, and the like. In an embodiment of the present disclosure, the desired store may also select the desired charity for an indefinite time rather than selecting the desired charity for a specific time frame. In an embodiment of the present disclosure, a single charity may be selected by multiple stores for donation. Further, the charity management module determines one or more analysis parameters for the desired charity based on the received charity information. In an exemplary embodiment of the present disclosure, the determined one or more analysis parameters include trends, demographics, the amount received from the purchaser, and the desired store.

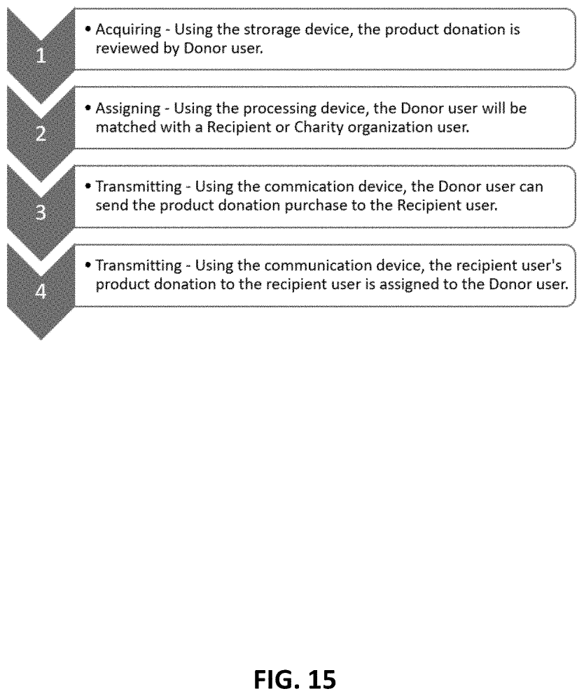

FIG. 15, Is an illustration of a sub-process method of the present mobile invention enables Donor-User to contribute funds based on their assessment of the product-donation request and the cost of the products. The sub-processing step begins by receiving, using the storage of the device, the request for the product donation. The product-donation request is accessed from the essential products which are selected by the recipient user and saved in the storage device. The sub-process continues by assigning, using the processing device, the Donor-User who accepts the product-donation request to a charity or recipient user. For example, the Recipient-User may create a product-donation request and send it out to various Donor-Users and charity organization users. The sub-process continues by transmitting, using the communication device, the Donor-User donation to the Recipient-User product-donation request wherein the Donor-User user is assigned to the Recipient-User. The Donor-User device is then only used to send a financial donation for the product-donation request when the Donor-User accepts the product-donation request, and their donation is assigned to the Recipient-User product-donation request.

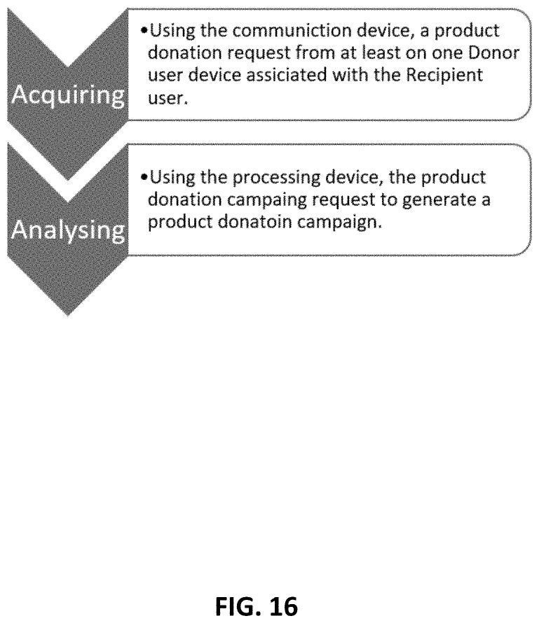

In reference to FIG. 16, a sub-process method of the present invention enables the Donor-User to share the Recipient-User's Product-Donation request to their social network after receiving the Recipient-user's product-donation request created by the recipient user. The sub-process begins with the step of receiving the product-donation request, using the communication device, a product-donation request from at least one Recipient-User's device associated with the Donor-User. The product-donation request contains informational data relating to a Recipient-User product-donation request. The sub-process continues by analyzing, using the processing device, the profile of the Recipient-User's request. The recipient's profile is a webpage that displays the information provided from the product-donation request. Each user of the mobile invention can share their profile, which includes the product donations they are requesting, through multiple communication and social media platforms, displaying their product-donation request and increasing the reach of their network.

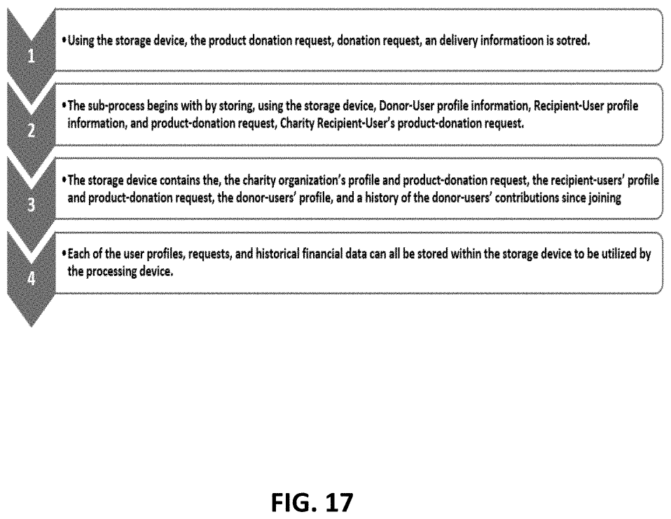

FIG. 17, Is an illustration which reflects a sub-process method of the present invention enables users to store their information with the present invention to be used or accessed later. The sub-process begins with the step by storing, using the storage device, Donor-User profile information, Recipient-User profile information, and product-donation request, Charity Recipient-User's product-donation request. The storage device contains the charity organization's profile and product-donation request, the recipient-users' profile and product-donation request, the donor-users' profile, and a history of the donor-users' contributions since joining. Each of the user profiles, requests, and historical financial data can all be stored within the storage device to be utilized by the processing device or to be accessed at a later date by any of the users.

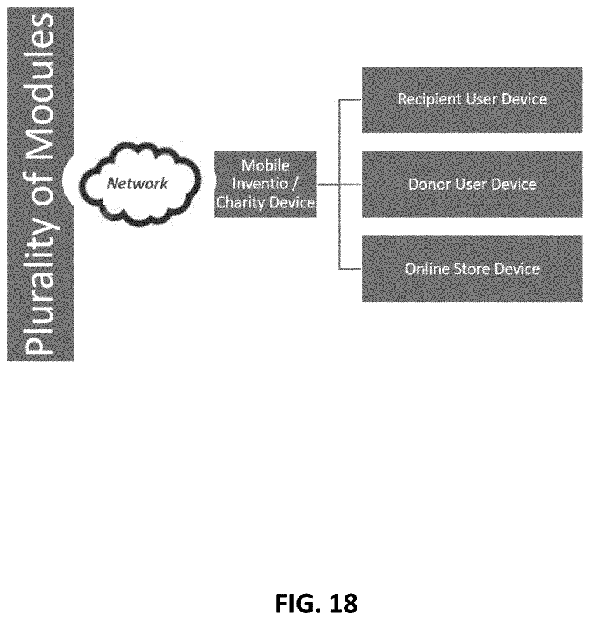

FIG. 18, Is an illustration of a block diagram of a system for facilitating product-donation requests for a product-donation campaign, in accordance with some embodiments. Accordingly, the system may include a communication device. Further, the communication device may be configured for receiving a recipient-Product-Donation request from at least one Recipient-User or a charity organization's device associated with at least one Donor-User. The Recipient-User's device is an electronic device utilized by a Recipient-User or charity organization. Further, the communication device may be configured for transmitting the Recipient-User's product-donation request to at least one Donor-User's device associated with the mobile invention. Further, the communication device may be configured for receiving a production-donation request from at least one Recipient-User's device associated with a user of the mobile invention. The communication device may be configured for transmitting the production-donation request to at least one Donor-User device associated with each Donor-User of a plurality of Donor-Users.

Donor-Users who agree to purchase the requested Product-Donation campaign on behalf of the Recipient and charity organization users will be donating the funds through the mobile application invention. These funds will be allocated to the charity organization “eBono” which is identified as a 501c3 nonprofit organization. Once the funds are paid to the charity organization (mobile invention), the contributed funds will be allocated for use by the Benevolence Funds account within the 501c3 organization (mobile invention). Financial funds used to support needy people are called the Benevolence fund. Benevolence Funds are used to help people who need financial assistance and are facing economic hardships due to various reasons like natural calamities, health issues, any accident, or any other natural cause.

When the funds are made available within the mobile application invention, customer service representatives for the mobile application invention will then use those funds to purchase the Product-Donation campaign request on behalf of the Donor-User. Because the financial contribution is donated directly to the eBono, a non-profit charity organization (mobile invention), any purchase that would be debited or credited through the eBono charity organization (mobile invention) as subtracted from its Benevolence funds, allows the purchases to be classified as a donation. Charitable gifts made to most nonprofit organizations that are officially recognized by the Internal Revenue Service (IRS) as having 501(c) (3) status are considered to be tax-deductible contributions. This system and method are what make the present disclosed mobile application invention able to provide essential products to families, individuals, and charity organizations in need as a donation tax write-off.

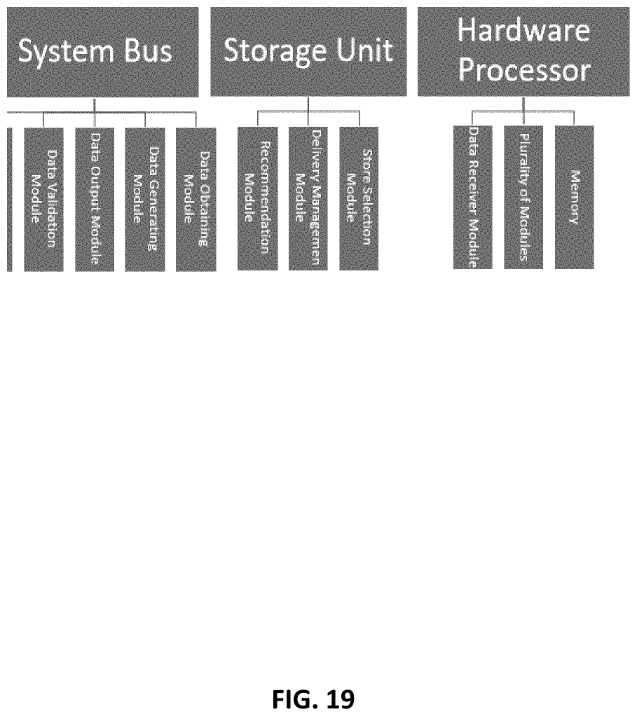

FIG. 19 Is an illustration of a block diagram that illustrates the systems and methods of the computing environment capable of facilitating product donation deliveries. The data receiver module is designed to receive a request from a Recipient-User to purchase one or more essential items from a desired store. In the design of the disclosed mobile application invention, one or more essential products are items offered for sale which include but are not limited to grocery items, medicines, and clothing products. A product-donation request includes types of one or more products, the quantity of one or more products, and a purchaser address. The desired store is in proximity to the Recipient User or charity organization user's address. In a system and method design of the present disclosure, the recipient-users may search and view all available images of one or more products in the form of a slideshow without selecting each item for viewing one or more products from various angles. The data receiver module is also configured to receive a mode of delivery of one or more products from the Donor-User. After a Recipient User selects the requested essential items, the mode of delivery for essential items includes a third-party delivery shopper going to the location of the stores, shopping for the essential product items, and delivering those essential items to the address provided by the Recipient User. In the system and method design of the present disclosure, the request is received from the recipient or charity organization user via an Artificial Intelligence (AI) chatbot, a mobile application, or a web browser. Artificial Intelligence (AI chatbot) is an automated program that taps integrates AI capabilities to interact with humans via text input, audio input, or both. In simple words, it is an application that can think like humans and carry out conversations. It is independent of human intervention. The system and methods defined for the disclosed mobile application include but are not limited to an AI chatbot, a mobile application, and a web browser.

Data for the essential items are configured to obtain approval from the third-party delivery partner after requests from the recipient users are created. When the data-obtaining module fails to obtain approval from the third-party delivery partner within a predefined time, the delivery management module may select the next third-party delivery shopper among the determined one or more third-party delivery shoppers to deliver one or more product donations to the Recipient Users.

Systems and methods in the disclosed mobile application invention, for purchasing one or more product-donations, the request must be paid for by the Donor Uses within the constructs of the mobile application. The Recipient Users may request to buy one or more products from the desired store so that the desired third-party delivery shopper may pick-up the one or more products from the desired store and deliver one or more products to the Recipient User of the mobile application invention. The desired store is a store that has signed up within the present mobile application invention by providing information regarding its product inventory. The product inventory is a list of all products available in the desired store. Further, the mobile application invention may include setting prices for the products listed in the store inventory. When the third-party delivery shopper receives a request for purchasing one or more products, the third-party delivery shopper first searches the one or more products in signed-up stores. When the personal shopper finds one or more products in the signed-up stores, the third-party delivery shopper purchases one or more products from the signed-up stores, paid for through the mobile application invention, and delivers one or more products to the recipient or charity organization users. The desired third-party delivery shopper may search for one or more products in stores that are not signed up. In an embodiment of the present disclosure, the information associated with the non-signed stores may be received from websites associated with such stores. The disclosed mobile invention may provide one or more suggestions to the desired third-party delivery shopper via one or more mobile invention devices. One or more suggestions are corresponding to the stores where the desired third-party delivery shopper can get one or more products. When the desired third-party delivery shopper finds one or more products, the delivery management module receives product information from the desired third-party delivery shopper.

In an embodiment of the present disclosure, the desired third-party delivery shopper may provide the product information by using the third-party delivery shopper device via the mobile application. In the present disclosure, the product information includes images of the product, the price of the product, the name of the product, the intended use of the product, and the like. The delivery management module for the mobile application provides the received product information to the third-party delivery shopper and obtains a confirmation from the third-party delivery shopper that the product information corresponds to one or more products requested by the Recipient User. When confirmation is obtained and the third-party delivery shopper pays for one or more products, the delivery management module sends a notification to the mobile application invention device to buy one or more products and deliver one or more products to the recipient/charity organization user. When the desired third-party delivery shopper fails to find one or more products, the third-party delivery shopper is notified that one or more products could not be found. When the total price of the one or remaining products corresponds to each of the detected one or more stores based on one or more shopping lists, the restored inventory details, and the predefined order schedule. Systems and methods include outputting the detected one or more stores along with the determined one or more purchase parameters on the graphical user interface of one or more third-party delivery shopper devices associated with the mobile application invention. Furthermore, the method includes receiving input from the third-party delivery shopper corresponding to one or more stores as well as one or more purchase parameters to select the desired store from the stores for purchasing the remaining products. Additionally, methods include detecting the stores in proximity to the recipient/charity organization users' addresses until all stores having multiple products are detected. When the multiple products are not available at a single desired store and rather available at multiple desired stores, a request is generated corresponding to each of the multiple desired stores for purchasing essential products that each desired store is having from the requested multiple products.

Included in the disclosed mobile application invention is a system and design for a third-party delivery shopper for delivering one or more essential products from the desired store to the recipient/charity organization user is determined based on the received request, received mode of delivery, and predefined information by using a product delivery-based Artificial Intelligence (AI) model upon receiving third-party delivery shopper as the model of delivery. In determining the third-party delivery shopper for delivering one or more products from the desired store to the recipient/charity organization based on the received request, the received mode of delivery, and the predefined information by using the third-party delivery shopper-based AI model upon receiving third-party delivery shopper as the model of delivery. The disclosed method includes determining one or more third-party delivery shoppers for delivering one or more products by correlating the received request, the received mode of delivery, and the predefined information using the product delivery-based AI model. In an exemplary embodiment of the present disclosure, the predefined information includes one or more order parameters received from the recipient/charity organization user, one or more delivery parameters received from the third-party delivery shopper, and a list of available third-party delivery shoppers. One or more order parameters include past preferences, feedback, the price range for the third-party delivery shopper, desired time of delivery, desired proximity range of the third-party delivery shopper from the desired store, and the like. In the system and method of the present disclosure, a user of the mobile application invention may add the third-party delivery shopper to a favorite list, such that he/she may directly select the third-party delivery shopper from the favorite list. The third-party delivery shopper may also be added to the favorite list based on the past preferences of the mobile application invention. Delivery parameters include but are not limited to the rates of delivering products fixed by the third-party delivery shopper based on distance, weight, the value of purchase, taxes, assessment of the delivery range of the third-party delivery shopper, the time required to deliver the products, working hours of the third-party delivery shopper stores for which the third-party delivery shopper is willing to deliver and the like. The present disclosure includes a method to determine one or more third-party delivery shoppers present in a predefined radius around the recipient/charity organization user. For example, the predefined radius maybe 15 miles around the recipient/charity organization users. In an embodiment of the present disclosure, the method includes determining the one or more third-party delivery shoppers have a rate of delivery matching the price range for the third-party delivery shopper. When the systems and methods fail to identify one or more third-party delivery shoppers according to the rate of delivery matching with the price range for the third-party delivery shopper, the method includes determining the one or more third-party delivery shopper having a rate of delivery less than the price range for the product donation. When the system and method fail to identify one or more third-party delivery shoppers at a rate of delivery less than the price range for the third-party delivery shopper method includes sharing the request of the recipient/charity organization users to all third-party delivery shopper present in the predefined radius around the recipient/charity organization. When a third-party delivery shopper from all the third-party delivery shopper accepts the request, he/she may be authorized to deliver one or more products to the recipient/charity organization. In an embodiment of the present disclosure, the third-party delivery shopper may invite other third-party delivery shoppers to the third-party delivery shopper device such that the other third-party delivery shopper downloads the mobile application to deliver the products for the recipient/charity organization users.

As disclosed in the systems and methods of the present mobile application invention, the desired store may be but is not limited to, a store that has signed up by providing its product inventory for purchase, a store that has not signed up, an e-commerce store, and the like. The e-commerce store is an e-commerce vendor that only sells online or through online shopping websites. The primary mode of delivery for the e-commerce store is through the third-party delivery shopper.

A system and method are designed to accept financial donations from Donor users that include the delivery charges/rates for the third-party delivery partners. These charges for the delivery include the delivery charge of the third-party delivery partner and the cost of the product donation request which is loaded into the temporary account. When the third-partner delivery copper delivers one or more products to the recipient/charity organization users, the third-party delivery shopper gets paid from the temporary account holding the money. In an embodiment of the present disclosure, while purchasing one or more products on behalf of the recipient/charity organization, the third-party delivery shopper may interact with the recipient/charity organization user via the third-party delivery shopper device to obtain non-specific product information, specific product information, and specific store information. In an exemplary embodiment of the present disclosure, the third-party delivery shopper may interact with the recipient/charity organization via the mobile application, phone call, and the like. For example, when the recipient/charity organization may request the third-party delivery shopper to buy over-the-counter medication, the third-party delivery shopper may interact with the recipient, and charity users to obtain the non-specific product information, such as which brand of the over-the-counter medication. Further, the third-party delivery shopper may interact with the recipient/charity organization user to obtain specific product information, such as the dosage of the over-the-counter medication. Furthermore, the third-party delivery shopper may interact with the recipient/charity organization to obtain specific store information, such as from which store the medication needs to be purchased.

The mobile application invention discloses systems and methods for a third-party delivery shopper who refuses to deliver one or more products or when no third-party delivery shopper is available to deliver one or more products, product makers and mobile application delivery drivers may deliver one or more products to the recipient/organization. The product makers and mobile application delivery drivers are personnel authorized to deliver one or more products to the recipient/charity organization upon obtaining a refusal from the third-party delivery shopper for the received request of the recipient/charity organization user or the unavailability of a third-party delivery shopper. In an embodiment of the present disclosure, each product maker and mobile application delivery driver is assigned to a particular territory. A product maker and mobile application delivery driver may be assigned for every 45 square miles. The system and method include determining one or more product makers and mobile application delivery drivers for delivering one or more products from the desired store to the recipient/charity organization users based on the received request, the received mode of delivery, and the predefined information by using the product delivery-based AI model upon obtaining a refusal from the third-party delivery shopper for the received request of the recipient/charity organization or unavailability of third-party delivery shopper.

The predefined information corresponding to the product maker and mobile application delivery driver includes one or more order parameters received from the recipient/charity organization user, one or more market parameters received from the market maker, and a list of available product maker and mobile application delivery drivers In the disclosed system and method, one or more product maker and mobile application delivery driver parameters include rates of delivering products fixed by the product maker and mobile application delivery driver, delivery range of the market maker, the time required to deliver the products, stores for which the market maker is willing to deliver, and the like. The method includes determining one or more product makers and mobile application delivery drivers on the graphical user interface of the one or product maker and mobile application delivery driver devices associated with the recipient users. The system and method include receiving input from the recipient users corresponding to the product maker and mobile application delivery driver to select the best suitable product maker and mobile application delivery driver for delivering one or more essential products. Reflected in the present disclosure of the mobile application, each of the product makers and mobile application delivery drivers may access a list of all product donation requests by using a product maker and mobile application delivery driver device. The product maker and mobile application delivery driver have the option to accept or refuse delivery of the one.

The estimated time required to deliver each of one or more products is dependent on but not limited to multiple factors including quantity and type of each of the one or more products, weather, and the like. The one or more purchase parameters include the price of the one or more products, offers associated with the one or products, the estimated delivery time of the one or more products, stock of the one or more products at each of the one or more stores, distance of each of the one or more stores from the purchaser address and the like. The offers associated with the products include discounts, cashback, rewards, and the like. In the system and method of the disclosure, the data output module outputs the detected one or more stores along with the determined one or more purchase parameters on a graphical user interface of the one or more third-party delivery shopper devices associated with the third-party delivery shopper.

Further, the Recipient User may request to purchase multiple products by using one or more shopping lists. The store selection module is configured to receive one or more shopping inputs from the recipient user to create one or more shopping lists. One or more inputs include the name of one or more shopping lists, the name of essential products to be added to one or more shopping lists, the quantity of the essential products, types of essential products, and the like. The recipient users may search for products and add the products to one or more shopping lists. Recipient users may also add product names to one or more shopping lists, delete products from one or more shopping lists, rename a shopping list, delete a shopping list, move products from one shopping list to another, share one or more shopping lists with his/her friend via one or more means using the one or more user devices, add a message and share the product donation request through means such as email, text, and the like.

A Recipient User may request to purchase specific products from one or more shopping lists. The store selection module detects one or more stores in proximity to the Recipient User address having all of the essential products or most of the essential products based on the created one or more shopping lists of the prestored inventory details. The store selection module determines the one or more purchase parameters associated with all of the essential products or most of the essential products corresponding to each of the detected one or more stores based on one or more shopping lists, the prestored inventory details, and the predefined order schedule. As disclosed, the data output module outputs the detected one or more stores along with the determined one or more purchase parameters on the graphical user interface of one or more recipient devices associated with the recipient users. The store selection module receives input from the mobile application device corresponding to one or more stores and one or more purchase parameters to select the desired store from one more store for purchasing all or most of the essential products.

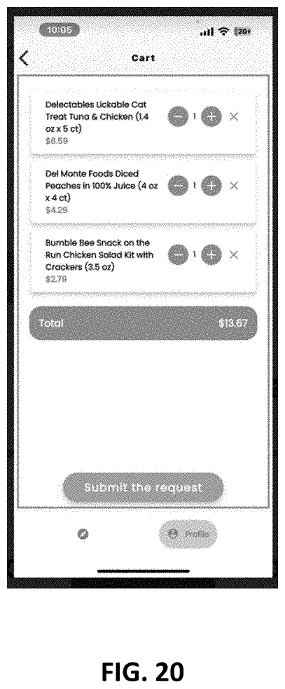

FIG. 20 Is an illustration of a graphical user interface screen of the mobile application invention for displaying a summary of all details of a selected product from one or more products. The recipient users may select the quantity of the selected products from the product details page. The method and system comprise one or more hardware processors, a memory, and a storage unit. One or more hardware processors, the memory, and the storage unit communicate through a system bus or any similar mechanism. The memory comprises a module in the form of programmable instructions enabled by one or more hardware processors. The modules include a store selection module, a data receiver module, a delivery management module, a recommendation module, a data obtaining module, a data generation module, a data output module, a data validation module, and a charity management module. One or more hardware processors means any type of computational circuits, such as but not limited to, a microprocessor unit, microcontroller, complex instruction set computing microprocessor unit, reduced instruction set computing microprocessor unit, instruction word microprocessor unit, explicitly parallel instruction computing microprocessor unit, graphics processing unit, digital signal processing unit, or any other type of processing circuit.

Hardware processors also include embedded controllers, such as generic or programmable logic devices or arrays, application-specific integrated circuits, and single-chip computers. The memory may be a non-transitory volatile memory or non-volatile memory. The memory may be coupled for communication with one or more hardware processors, such as computer-readable storage. Hardware processors may execute machine-readable instructions and/or source code stored in memory. A variety of machine-readable instructions are stored in and retrieved from memory. The memory includes any elements for storing data and machine-readable instructions, such as read-only memory, random access memory, erasable programmable read-only memory, electrically erasable programmable read-only memory, a hard drive, a removable media drive for compact disks, digital video disks, diskettes, magnetic tape cartridges, and memory cards. In the present embodiment, the memory includes modules stored as machine-readable instructions on any of the above-mentioned storage media which communicates by the integration of one or more hardware processors. The storage unit may be cloud storage which stores information, a predefined order schedule, an order schedule, and dynamic Navigation.

FIG. 20 Is an illustration of one or more computer programs related to payments that can be configured to perform operations or actions by including instructions for a data processing apparatus causing the device to perform the actions. In the disclosed, network interface components may include a Digital Subscriber Line (DSL) modem, a Public Switched Telephone Network (PTSN) modem, an Ethernet device, a broadband device, a satellite device, and/or various other types of wired and/or wireless network communication devices including microwave, radio frequency, infrared, Bluetooth®, Bluetooth low-energy, near field communication (NFC) devices, and/or the like. The merchant device may include the mobile application device designed to receive and transact with users in receiving and donating.

The third-party service provider computer may be maintained, for example, by a third-party service provider, which may provide payment processing services for the merchant. In one example, the third-party service provider may be provided by Stripe inc. The third-party service provider computer may be associated with a user of the primary computing application device. The third-party service provider computer includes one or more payment processing applications, which may be configured to process payment information received from the merchant device or from a selection at the primary user device. The payment application of the merchant device may receive payment information from users of the mobile application invention to purchase a good offered by the merchant.

Upon receipt of the payment information, the payment application may transmit the payment information to the third-party service provider's computer. The payment processing application of the third-party service provider computer may receive and process the payment information. The payment application can present a payment code on a display of the user device associated with the merchant. The payment processing application can present a successful transaction notification on the display of the user's device when the application has been authorized and is ready for processing.

The third-party service provider computer may execute the other applications to perform other operations corresponding to the third-party service provider computer. This may include security applications for implementing security features, programmatic client applications for interfacing with APIs over the network, or other types of applications. Applications may also include additional communication applications, such as email, texting, voice, and IM applications that enable communication of emails, calls, texts, and other notifications through the network.

The primary user device may be implemented as a communication device with appropriate hardware and software configured for wired and/or wireless communication with the merchant device and third-party service provider computer. The primary user device can include a personal computer (PC), a smartphone, a laptop/tablet computer, a wristwatch with appropriate computer hardware resources, eyeglasses with appropriate computer hardware (e.g., GOOGLE GLASS®), other types of wearable computing devices, implantable communication devices, and/or other types of computing devices capable of transmitting and/or receiving data. The primary user device may be a mobile device communicating with a wearable device (or secondary user device), merchant device, or directly with the third-party service provider system.

The interface module may provide interfaces for interacting with disclosed mobile application system. The user can download and upload information through the application interface. The interface can be provided as application software that can be installed on a device. The application software can be developed for Android, iOS, and any other known operating platform for mobile devices and computing systems. The application software can be made available through a distribution service provider such as Google Play operated and developed by Google, and/or the app store by Apple. A website-based interface can be provided through the world-wide-web.

Users can register on the disclosed system through the profile module. The profile module can create login credentials for a user to securely access the disclosed mobile application system through their devices. The user device can be a laptop workstation, desktop, smartphone, tablet computer, thin client, and similar products. The profile module is a system that can provide a registration form through a user interface implemented on the user's device. The user interface is also used to receive login credentials and authorize the user to access the disclosed mobile application system. The login credentials include a username and a password. The password can be any alpha-numeric code and include symbols and the like. Biometric based authentication and login are also within the scope of the present invention. Through the registration form, the profile module can obtain information about the user, such as name, contact details, addresses, affiliations, and like, at step. A third-party verification system and method are also within the scope of the present invention. The profile module can then save the profile in a quarriable database that allows searching of the profiles based on keywords. The profiles can be edited later by the user and more information can also be obtained from the user after registration.

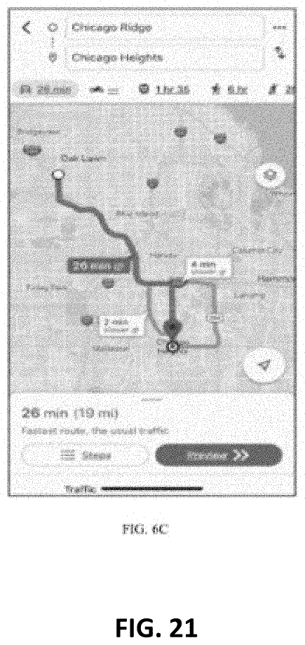

FIG. 21 Further, the recipient user may select the buy it option to access a geolocation page. The graphical user interface screen of the mobile application for depicting the geolocation page. The recipient user may select the store by clicking on the store icon in map view or the recipient user may view all the stores carrying one or more products by selecting the list of stores option, as shown in the figure. The recipient may tap on the list icon to add the product to one or more shopping lists. When the recipient taps on the list icon, the list-icon turns into a plus icon. When the purchaser again taps on the minus icon, the product is removed from one or more shopping lists and the plus icon turns into the list-icon again.

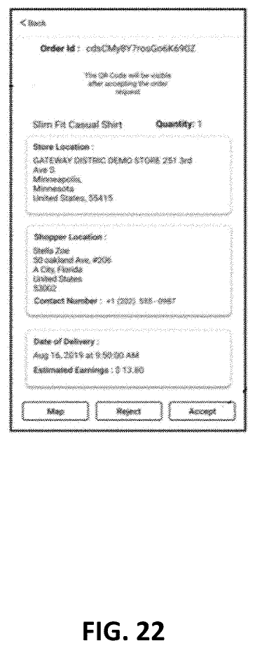

FIG. 22 is a graphical user interface screen of a mobile application capable of facilitating delivery of the one or more products, in accordance with another embodi-ment of the present disclosure. In an embodiment of the present disclosure, the mobile application is used by the desired personal shopper. The desired personal shopper may tap on order ID under open orders tab to access order details page. The graphical user interface screen of the mobile application depicting the order details page. In the order details page, the desired personal shopper may view all the order details, such as store location, shopper location, date of delivery, time of delivery. By looking at all these details, the desired personal shopper may accept or reject the request. Personal shopper may also open map to check location of the purchaser. When the desired personal shopper accepts the request, new order falls under accepted order.

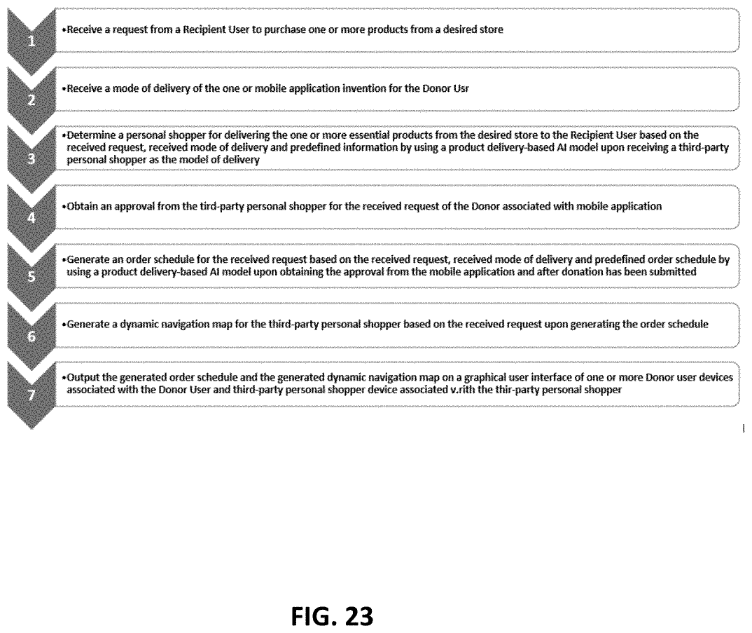

FIG. 23 Is a graphical user interface screen of the mobile application depicting the delivery methods screen. By using the delivery methods page the Recipient User may select the mode of delivery of one or more products. In the current embodiment, there are two modes of delivery i.e., pick-up and personal shopping. The graphical user interface screen is of the mobile application depicting a payment summary page. Using the payment summary, the purchaser may view the total price, delivery details, and grand total, as shown in FIG. 21. In an embodiment of the present disclosure, the Donor User may select the continue/confirm option to access the payment page.

A system and design for a third-party delivery shopper for delivering one or more essential products from the desired store to the recipient/charity organization user is determined based on the received request, received mode of delivery, and predefined information by using a product delivery-based Artificial Intelligence (AI) model upon receiving third-party delivery shopper as the model of delivery. In determining the third-party delivery shopper for delivering one or more products from the desired store to the recipient/charity organization based on the received request, the received mode of delivery, and the predefined information by using the third-party delivery shopper-based AI model upon receiving third-party delivery shopper as the mode of delivery. The disclosed method includes determining one or more third-party delivery shoppers for delivering one or more products by correlating the received request, the received mode of delivery, and the predefined information using the product delivery-based AI model. In an exemplary embodiment of the present disclosure, the predefined information includes one or more order parameters received from the recipient/charity organization user, one or more delivery parameters received from the third-party delivery shopper, and a list of available third-party delivery shoppers. One or more order parameters include past preferences, feedback, the price range for the third-party delivery shopper, desired time of delivery, desired proximity range of the third-party delivery shopper from the desired store, and the like. In the system and method of the present disclosure, a user of the mobile application invention may add the third-party delivery shopper to a favorite list, such that he/she may directly select the third-party delivery shopper from the favorite list. The third-party delivery shopper may also be added to the favorite list based on the past preferences of the mobile application invention. Delivery parameters include but are not limited to the rates of delivering products fixed by the third-party delivery shopper based on distance, weight, the value of purchase, taxes, assessment of the delivery range of the third-party delivery shopper, the time required to deliver the products, working hours of the third-party delivery shopper stores for which the third-party delivery shopper is willing to deliver and the like. The present disclosure includes a method to determine one or more third-party delivery shoppers present in a predefined radius around the recipient/charity organization user. For example, the predefined radius 15 miles around the recipient/charity organization users. In an embodiment of the present disclosure, the method includes determining the one or more third-party delivery shoppers have a rate of delivery matching the price range for the third-party delivery shopper. When the systems and methods fail to identify one or more third-party delivery shoppers according to the rate of delivery matching with the price range for the third-party delivery shopper, the method includes determining the one or more third-party delivery shopper having a rate of delivery less than the price range for the product donation. When the system and method fail to identify one or more third-party delivery shoppers at a rate of delivery less than the price range for the third-party delivery shopper method includes sharing the request of the recipient/charity organization users to all third-party delivery shopper present in the predefined radius around the recipient/charity organization. When a third-party delivery shopper from all the third-party delivery shopper accepts the request, he/she may be authorized to deliver one or more products to the recipient/charity organization. In an embodiment of the present disclosure, the third-party delivery shopper may invite other third-party delivery shoppers to the third-party delivery shopper device, such that the other third-party delivery shopper downloads the mobile application to deliver the products for the recipient/charity organization users.

As disclosed in the systems and methods of the present disclosure, the desired store may be but is not limited to, a store that has signed up by providing its product inventory for purchase, a store that has not signed up, an e-commerce store, and the like. The e-commerce store is an e-commerce vendor that only sells online or through online shopping websites. The primary mode of delivery for the e-commerce store is through the third-party delivery shopper.

A system and method are designed to accept financial donations from Donor users that include the delivery charges/rates for the third-party delivery partners. These charges for the delivery include the delivery charge of the third-party delivery partner and the cost of the product donation request which is loaded into the temporary account. When the third-partner delivery shopper delivers one or more products to the recipient/charity organization users, the third-party delivery shopper gets paid from the temporary account holding the money. In an embodiment of the present disclosure, while purchasing one or more products on behalf of the recipient/charity organization, the third-party delivery shopper may interact with the recipient/charity organization user via the third-party delivery shopper device to obtain non-specific product information, specific product information, and specific store information. In an exemplary embodiment of the present disclosure, the third-party delivery shopper may interact with the recipient/charity organization via the mobile application, phone call, and the like. For example, when the recipient/charity organization may request the third-party delivery shopper to buy over-the-counter medication, the third-party delivery shopper may interact with the recipient, and charity users to obtain the non-specific product information, such as which brand of the over-the-counter medication. Further, the third-party delivery shopper may interact with the recipient/charity organization user to obtain specific product information, such as the dosage of the over-the-counter medication. Furthermore, the third-party delivery shopper may interact with the recipient/charity organization to obtain specific store information, such as from which store the medication needs to be purchased.

The mobile application invention discloses systems and methods for a third-party delivery shopper who refuses to deliver one or more products or when no third-party delivery shopper is available to deliver one or more products, product makers and mobile application delivery drivers may deliver one or more products to the recipient/organization. The product makers and mobile application delivery drivers are personnel authorized to deliver one or more products to the recipient/charity organization upon obtaining a refusal from the third-party delivery shopper for the received request of the recipient/charity organization user or the unavailability of a third-party delivery shopper. In an embodiment of the present disclosure, each product maker and mobile application delivery driver is assigned to a particular territory. A product maker and mobile application delivery driver may be assigned for every 45 square miles. The system and method include determining one or more product makers and mobile application delivery drivers for delivering one or more products from the desired store to the recipient/charity organization users based on the received request, the received mode of delivery, and the predefined information by using the product delivery-based AI model upon obtaining a refusal from the third-party delivery shopper for the received request of the recipient/charity organization or unavailability of third-party delivery shopper. The predefined information corresponding to the product maker and mobile application delivery driver includes one or more order parameters received from the recipient/charity organization user, one or more market parameters received from the market maker, and a list of available product maker and mobile application delivery drivers In the disclosed system and method, one or more product maker and mobile application delivery driver parameters include rates of delivering products fixed by the product maker and mobile application delivery driver, delivery range of the market maker, the time required to deliver the products, stores for which the market maker is willing to deliver, and the like. The method includes determining one or more product makers and mobile application delivery drivers on the graphical user interface of the one or product maker and mobile application delivery driver devices associated with the recipient users. The system and method include receiving input from the recipient users corresponding to the product maker and mobile application delivery driver to select the best suitable product maker and mobile application delivery driver for delivering one or more essential products. Reflected in the present disclosure of the mobile application, each of the product makers and mobile application delivery drivers may access a list of all product donation requests by using a product maker and mobile application delivery driver device. The product maker and mobile application delivery driver have the option to accept or refuse delivery of the one.

The estimated time required to deliver each of one or more products is dependent on but not limited to multiple factors including quantity and type of each of the one or more products, weather, and the like. The one or more purchase parameters include the price of the one or more products, offers associated with the one or products, the estimated delivery time of the one or more products, stock of the one or more products at each of the one or more stores, distance of each of the one or more stores from the recipient user address. The offers associated with the products include discounts, cashback, rewards, and the like. In the system and method of the disclosure, the data output module outputs the detected one or more stores along with the determined one or more purchase parameters on a graphical user interface of the one or more third-party delivery shopper devices associated with the third-party delivery shopper.

The Recipient User may request to purchase multiple products by using one or more shopping lists. The store selection module is configured to receive one or more shopping inputs from the recipient user to create one or more shopping lists. One or more inputs include the name of one or more shopping lists, the name of essential products to be added to one or more shopping lists, the quantity of the essential products, types of essential products, and the like. The recipient users may search for products and add the products to one or more shopping lists. Recipient users may also add product names to one or more shopping lists, delete products from one or more shopping lists, rename a shopping list, delete a shopping list, move products from one shopping list to another, share one or more shopping lists with his/her friend via one or more means using the one or more user devices, add a message and share the product donation request through means such as email, text, and the like. A Recipient User may request to purchase specific products from one or more shopping lists. The store selection module detects one or more stores in proximity to the Recipient User address having all of the essential products or most of the essential products based on the created one or more shopping lists of the prestored inventory details provided in the mobile application invention. The store selection module determines the one or more purchase parameters associated with all of the essential products or most of the essential products corresponding to each of the detected one or more stores based on one or more shopping.

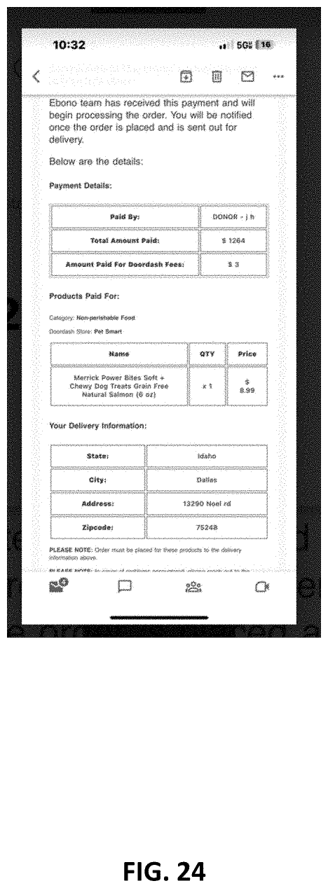

FIG. 24, Is the graphical user interface screen of the mobile application showing the payment of a product donation, what products were purchased, along with its pertinent details for delivery. This is the graphical user interface screen of the mobile application showing order details, such as order ID, store address, product details, and the like. The disclosed mobile application invention integrates an interface screen of the mobile application for accessing open orders, closed orders, canceled orders, profiles, wallets, and the like. Donors, Recipients, and Charity Organization Users are all notified when the order has been successfully delivered. Additionally, the user interface screen of the mobile application can provide desired personal choice price, purchaser address, estimated delivery time, and the like.

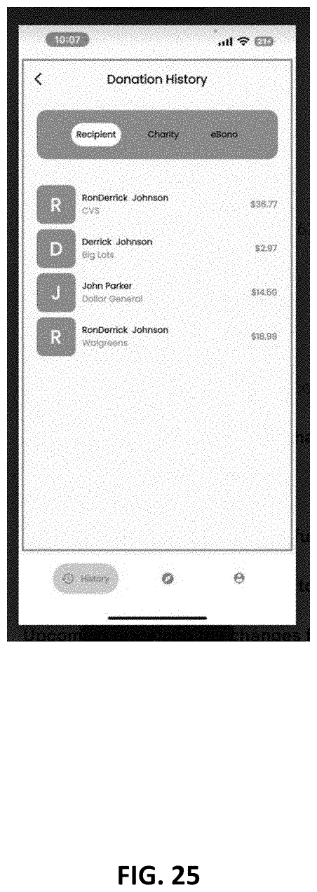

FIG. 25, Is an illustration which includes details for the Donor Users regarding the history report of their product donations which include product details and delivery details shown in the mobile application. The history report is provided for tracking purposes so that the Donors are able to receive all of the tax benefits related to charity donation described in the present mobile application invention.

All drawings and illustrations are to describe specific versions of the present mobile application invention and are not proposed to limit the scope of the present mobile application invention. Although the disclosed mobile application invention has been explained in relation to its preferred embodiment, it is to be understood that many other possible modifications and variations can be made without departing from the spirit and scope of the invention as hereinafter claimed.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein; the invention should therefore not be limited by the above-described embodiment, systems, method, and illustrative examples, but by all embodiments and methods within the scope and spirit of the invention which is outlined in the following claim.

1. A method for essential product donation fundraising, the method implemented within a system comprising a processor and a memory, the method comprising the steps of
mobile application invention implementation inclusive of a system consisting of memory and processor, the method of the implemented steps includes; generating by an interface module, an interface for interacting and communicating with the system; creating a profile module implementation with the system and upon execution by the processor, a profile of the user will be created inclusive of the name, contact information associated with a fintech module and its technology used to support and enable banking and financial services;
system by which one or more financial accounts for receiving funds from one or more Donor Users by the fintech module, a payment interface for electronically receiving the funds from one or more Donor-Users; a networking module for Product-Donation Campaigning for presenting a cause to one or more Donor-Users for receiving the funds, wherein the Product-Donation Campaign has a unique id, wherein the payment interface is coupled to the product donation campaign; and recording transactions relating to the transfer of funds from one or more Donor-Users in response to the product donation campaign, wherein the transactions are tagged with the unique id and transferred from one or more financial accounts using predetermined instructions into the financial accounts of a 501c3 nonprofit organization associated with the mobile application invention.
A method of providing, by the networking module, an interface for transferring funds to the business banking account associated with the mobile application invention for the purchase of essential products for the Recipient-Users (indigent individuals, families, and charity organizations, nonprofit organizations) of the mobile invention; systems and methods to allow recipients and charity organizations access to the in-app stores to select essential products; these are stores that have been selected that carry the essential items recognized in the mobile application invention; recipient-Users are directed to choose a price category that best reflects the estimated cost of the essential items they are requesting from the specified store; recipient-Users will only be able to select the estimated price category for the allotted time specified in the mobile application invention to prevent abuse of the service; systems and methods for pausing the mobile application accounts for the Recipient-User account for weekly intervals depending on the price category; the Recipient-User will be required to wait for the specified time before they are allowed to make another request in the specified price category; after the Recipient-User selects the essential products and price categories, the mobile invention will prompt the users to select potential Donor-Users from their contact list; a Donor User from one or more of the Recipient-User potential Donor-User contact lists would transfer the funds into the business banking account of the mobile app invention to purchase the requested essential products for the Recipient-User.
Systems and method of receiving, through the profile module, identification documents, of the users of the mobile application invention for verification; systems and methods comprised within the networking module to create a main profile page associated with the users, the main page comprises the name and the contact detail of the users, information on the essential products requested by the Recipient-User, information about the funds contributed by the Donor Users and the transactions associated with the Product Donation Campaign requested, wherein the transactions are tracked using the unique id of the product request; method for tracking the activities of the Donor-User in relation to the system; generating rewards/incentive programs for the Donor-Users based on their overall contributions and making available any tax-related benefits.
Method for automatically generating receipts for the funds received from one or more Donor Users to avail of any benefits; the method further comprises steps for storing the contributions of the Donor-User, product donation requests made by the Recipient-User, and Charity organization users; a system for Product-Donation Campaigns, the system comprising a processor and a memory configured to integrate a method for generating, by an interface module for interacting with the system; creating, by a profile module implemented with the system and upon execution by the processor, a profile of the Donor-User, Recipient, and Charity organization users; the profile comprises contact information such as the name, and details of the user; associating, by a fintech module implemented with the system and upon execution by the processor, one or more cash/financial accounts to the profile for receiving funds from one or more Donor-Users; providing, by the fintech module, a payment interface for electronically receiving the funds from the one or more Donor-Users; populating, by a networking module, a Product-Donation Campaign for presenting a cause relating to the Product-Donation Campaign, to the one or more Donor-Users for receiving the funds, wherein the Product-Donation Campaign has a unique id, wherein the payment interface is coupled to the donation campaign; and recording transactions relating to the transfer of the funds from the one or more Donor Users in response to the product campaign, wherein the transactions are tagged with the unique id of the campaign.
A system configured to implement the transferring of a portion of cash/financial amount from one or more cash accounts to a product donation campaign automatically paid based on predetermined instructions; a system configured to implement the steps of selecting a Donor User from the one or more Donor-Users from whom the funds are transferred to the mobile application invention to be used for the purchase of essential product donations; a system is further configured to implement the steps of receiving, by the profile module, identification documents, of the user for verification; a system configured to implement the steps of automatically generating receipts to reflect what was purchased, the cost, the date, the location of delivery, and a history of all transactions and donated funds received from one or more Donor-Users to avail of any benefits.
The system of the mobile application integrates a development platform that includes a web-based service accessed by the users of the mobile application invention through the Internet; The system of the mobile invention has physical memory storing instructions that further cause the electronic apparatus to receive from the user identifying information for the mobile application consisting of a name, a type, a category, a description, a unique identifier, and a date; The system of the mobile application invention has physical memory storing instructions that further cause the electronic apparatus to retrieve, in response to receiving the request from the user to modify an existing mobile application, previously stored application data associated with the existing mobile application; The system of the mobile application invention has physical memory storing instructions that are further configured to cause the electronic apparatus to store the application data in an application database stored on the physical memory of the computing device.
The system of the mobile application invention has at least one set of target mobile devices is selected from the group consisting of a mobile device category, a mobile device type, and a mobile device model; The system of the mobile application invention integrates a user-defined functionality represented by at least one application component which includes device-specific functionality associated with at least one set of target mobile application devices; The system of the mobile application invention integrates specific functionality, which is selected from the group consisting, but not limited to, the compass, GPS, a gyroscope, a touch screen, a camera, a speaker, a microphone, short-range radio communication, Wi-Fi, USB connectivity, and a proximity sensor; The system of the mobile application invention has an application property associated with a default set of functionalities that can be included in the mobile application; The system of the mobile application represents design elements consisting of a layout, a theme, an orientation, a font, and a style.
The system of the mobile application invention has user-defined content represented by at least one content element including content data selected from the group consisting of an image, a video, a sound, a song, a link, an animation, a document, and text; The system of the mobile application invention has user-defined content represented by at least one content element including content data uploaded by the user; The system of the mobile application invention has physical memory storing instructions that further cause the electronic device to submit the mobile application, in response to receiving an indication from the user to install the mobile application to end users, to at least one digital distribution platform associated with the at least one set of target mobile devices.
The system of the mobile application invention has physical memory storing instructions that further cause the electronic apparatus to automatically manage a submission process associated with submitting the mobile application to at least one digital distribution platform; The system of the mobile application invention has the instructions to retrieve at least a portion of the compiled data by the mobile device from a remote storage location comprising of querying an application database associated with the mobile application to retrieve compiled application data associated with the profile identifiers of the mobile application; A system comprised of the steps of providing an interface for transferring funds to one or more Donor Users to the mobile invention for the purchase of Recipient-User or charity organization's product-donation request;
A system comprised of the steps for disabling the Recipient-User account for a specified time after the Recipient-User selects a price category; A computing system for facilitating the delivery of one or more products comprised of one or more hardware processors; and a memory coupled to the one or more hardware processors, wherein the memory comprises a plurality of modules in the form of programmable instructions; A computing system comprised of executable hardware processors, wherein the plurality of modules comprises a data receiver module configured to receive a request from a recipient user to purchase one or more products from a desired store, wherein the request comprises; types of one or more products, the quantity of the one or more products and a purchaser address; and receive a mode of delivery of the one or more products from the donor user through the mobile invention to be qualified as a tax-deductible donation; A computing system wherein the mode of delivery comprises shopping of essential product items requested by the Recipient User of the mobile application, picking up the essential product items at the desired store by a third-party personal shopper.
A computing system for a delivery management module configured to determine the third-party delivery shopper for delivering one or more products from the desired store to the recipient user based on the received request received mode of delivery and predefined information by using a product delivery-based Artificial Intelligence (AI) model upon receiving third-party delivery shopper as the model of delivery, wherein the received request is forwarded to the determined third-party delivery shopper; a data obtaining module configured to obtain an approval from the third-party delivery shopper for the received request of the recipient user; A computing system for a data generation module configured to generate an order schedule for the received request based on the received request, received mode of delivery, and predefined order schedule by using a product delivery-based AI model upon obtaining approval from the third-party delivery shopper wherein the order schedule comprises; recipient user's address, desired store address information associated with the one or more products, the estimated delivery time of the one or more products, and order number.
A computing system for integrating a navigation map for the third-party delivery shopper based on the received request upon generating the order schedule, wherein the navigation map comprises a path flow from a source address to a destination address and wherein the source address is the live location of the third-party delivery shopper, and the destination address is the recipient user's address.
A computing system for integrating a data output module configured to output the generated order schedule and the generated navigation map on a graphical user interface of one or more recipient user's devices associated with the recipient and third-party delivery shopper device associated with the third-party delivery shopper; A computing system comprised of a store selection module configured to detect one or more stores in proximity to the recipient user's address having one or more products based on the received request and prestored inventory details; A computing system for determining one or more purchase parameters associated with the one or more products corresponding to each of the stores based on the recipient user's received request, prestored inventory details, and the predefined order schedule, wherein the one or more purchase parameters comprise; the price of the one or more products, offers associated with the one or products, the estimated delivery time of the one or more products, stock of the one or more products at each of the one or more stores and distance of each of the one or more stores from the recipient user's address and wherein the detected one or more stores along with the determined one or more purchase parameters are outputted on the graphical user interface of the one or more third-party delivery shopper devices associated with the recipient.
A computing system for receiving input from the donor user corresponding to the outputted one or more stores and the outputted one or more purchase parameters to select the desired store from the one more stores for purchasing the one or more products associated with the product donation of the Recipient User; A computing system wherein the request is received from the mobile application via one an AI chatbot, a mobile application, and a web browser.
A computing system wherein in determining the third-party delivery shopper for delivering the one or more products from the desired store to the recipient user based on the received request, the received mode of delivery and the predefined information by using the product delivery-based AI model upon receiving third-party delivery shopper as the model of delivery, the delivery management module is configured to; determine one or more third-party delivery shopper for delivering the one or more products by correlating the received request, the received mode of delivery and the pre-defined information using the product delivery-based AI model, wherein the determined one or more third-party delivery shopper are outputted on the graphical user interface of the one or more recipient user's devices associated with the purchaser; and receive an input from the recipient user corresponding to the outputted one or more third-party delivery shopper to select best suitable third-party delivery shopper from the determined one or more third-party delivery shopper for delivering the one or more products.
The computing system wherein the pre-defined information comprises one or more order parameters received from the recipient user, one or more delivery parameters received from the third-party delivery shopper, and a list of available third-party delivery shoppers, wherein the one or more order parameters comprise of past preferences, feedbacks, the price range for the third-party delivery shopper, desired time of delivery and desired proximity range of the third-party delivery shopper from the desired store and wherein the one or more delivery parameters comprise rates of delivering products fixed by the third-party delivery shopper
based on distance, weight, the value of purchase, rating of the recipient and recipient user's address, delivery range of the third-party delivery shopper, the time required to deliver the products, working hours of the third-party delivery shopper and stores for which the third-party delivery shopper is willing to deliver.
The computing system comprising of a data validation module configured to; generate a security code corresponding to the order schedule for both the recipient user and the third-party delivery shopper; validate the security code for the third-party delivery shopper for purpose of picking-up the one or more products from the desired store based on prestored third-party delivery shopper details; and validate the security code for the recipient user for purpose of delivering the one or more products donations at the recipient user's address based on prestored Recipient User details.
The computing system wherein the data receiver module is configured to receive a delivery confirmation message from the third-party delivery shopper upon delivery of one or more product donations to the recipient users based on the generated navigation map and validation of the security code associated with the recipient users; The computing system wherein the store selection module is configured to; receive one or more shopping inputs from the recipient user to create one or more shopping lists, wherein the one or more inputs comprise; the name of the one or more shopping lists, name of multiple products to be added in the one or more shopping lists, quantity of the multiple products and types of the multiple products; detect one or more stores in Proximity to the recipient user's address having one of; all of the multiple products and most of the multiple products based on the created one or more shopping lists and the prestored inventory details; determine the one or more purchase parameters associated with the one; all of the multiple products and most of the multiple products corresponding to each of the detected one or more stores based on the one or more shopping lists, the prestored inventory details and the predefined order schedule, wherein the detected one or more stores along with the determined one or more purchase parameters are outputted on the graphical user interface of the one or more purchaser devices associated with the recipient user; receive an input from the donor user corresponding to the outputted one or more stores and the outputted one or more purchase parameters to select the desired store from the one more stores for purchasing the one of all of the multiple products and most of the multiple products; detect one or more stores in proximity to the recipient users address having remaining products of the one or more shopping lists based on the created one or more shopping lists and the prestored inventory details upon detecting most of the multiple products; determine the one or more purchase parameters associated with the remaining products corresponding to each of the detected one or more stores based on the one or more shopping lists, the prestored inventory details and the predefined order schedule, wherein the detected one or more stores along with the determined one or more purchase parameters are outputted on the graphical user interface of the one or more purchaser devices associated with the recipient user; and receive an input from the donor user corresponding to the outputted one or more stores and the outputted one or more purchase parameters to select the desired store from the one more stores for purchasing the remaining products.
The computing system comprising of a charity management module configured to; receive charity information from at least one of the desired store and the donor user for making donations to a desired charity from one or more predefined charities, wherein the charity information comprises; one or more donor user parameters received from the donor and one or more store parameters received from the desired store, wherein the one or more recipient user parameters comprise; name of the charity and amount to be donated to charity and wherein the one or more store parameters comprise; name of the desired charity, custom percentage of revenue to be donated and time-frame for donation; and determine one or more analysis parameters for the desired charity based on the received charity user information, wherein the determined one or more analysis parameters comprise; trends, demographics and the amount received from the donor user and the desired store and wherein the determined one or more analysis parameters are outputted on a graphical user interface of charity device associated with the desired charity.
The computing system comprising of a recommendation module configured to generate one or more recommendations for the identification of a personal shopper corresponding to the rate of delivery the one or more products based on the received request received mode of delivery, and predefined information by using the product delivery-based AI model, wherein the generated one or more recommendations are outputted on the graphical user interface of the personal shopper device; the method wherein the request is received from the purchaser via one of; artificial Intelligence (AI chatbot) is an automated program that taps into AI capabilities to interact with humans via text input, audio input, or both, in simple words, it is an application that can think like humans and carry out conversations.
The method comprising of receiving a delivery confirmation message from the third-party delivery shopper upon delivery of one or more products to the purchaser based on at least one of the generated dynamic navigation maps and validation of the security code associated with the third-party delivery shopper; a method and system for communicating real-time updates, through push notification technology associated with the mobile application invention to communicate messages such as but not limited to the following notifications.
